(19) United States
(12) Patent Application Publication
(10) Pub. No.: US 2026/0098822 A1
(43) Pub. Date: Apr. 9, 2026

(54) Systems and Methods for Real-Time Scan Guidance for X-Ray Imaging

(71) Applicant: Rapiscan Holdings, Inc., Torrance, CA (US)

(72) Inventor: Aaron Judy Couture, Reading, MA (US)

(21) Appl. No.: 19/348,451

(22) Filed: Oct. 2, 2025

Related U.S. Application Data
(60) Provisional application No. 63/704,660, filed on Oct. 8, 2024.

(51) Int. Cl. G01N 23/083; G01N 23/04; G01T 1/02

(52) U.S. Cl. CPC G01N 23/083; G01N 23/04; G01T 1/023; G01N 2223/3303; G01N 2223/408

(57) ABSTRACT

A scanning environment includes a real-time signal generation for remote detection of the position of a portable X-ray scanning system with reference to a transmission detector. Prior to generating an X-ray scan, the portable X-ray scanning system must be positioned such that X-rays generated by an X-ray source, of the portable X-ray scanning system, strikes all or a portion of the transmission detector. In some cases, the transmission detector panel may be positioned at a distance from the portable X-ray scanning system. The transmission detector may even be out of sight of the X-ray source. For these cases a real-time signal is generated and processed to indicate whether an X-ray beam is striking the transmission detector. If the X-ray beam is not striking the transmission detector, feedback is generated, real-time, indicating a direction in which the X-ray beam should be moved.

### CROSS-REFERENCE

The present specification relies on U.S. Provisional Patent Application Number 63/704,660, titled “Systems and Methods for Real-Time Scan Guidance for X-Ray Imaging”, filed on Oct. 8, 2024, for priority. The above-mentioned application is herein incorporated by reference in its entirety.

### FIELD

The present specification is related generally to the field of X-ray scanners. More specifically, the present specification is related to systems and methods of determining if an X-ray beam is striking a transmission detector and/or determining a direction or position of the X-ray beam with respect to the transmission detector.

### BACKGROUND

Scanning devices use various methods to sense or detect concealed materials and objects. These scanning devices include transmission X-ray imaging systems, Compton scatter-based backscatter imaging systems, chemical sniffing trace detection equipment, thermal imaging camera systems, and other such systems. The scanning devices may be used either alone or in combination to provide a comprehensive level of security. However, the scanning devices tend either to be large and expensive (e.g. transmission X-ray imaging systems) or insensitive to carefully hidden materials (e.g. trace detection equipment and camera systems) which means that their utility is restricted to certain high throughput situations such as seaports and land borders, airport checkpoints and other high throughput areas.

Portable scanning systems, such as handheld systems, typically employ X-ray beams that not only reveal interior objects by analyzing backscattered radiation but, in some applications, can obtain additional information by a simultaneous analysis of transmission (TX) and backscattered (BX) radiation. In this configuration, the handheld scanner comprises one or more BX detectors while a TX detector is placed at a distance from the scanner and is in wireless or wired communication with the handheld scanner. However, in such cases the TX detector is physically separated from the scanning system and may be located farther from the X-ray source, where it is not easily seen.

Accordingly, there is need for systems and methods for real-time determination of whether an X-ray beam is striking a transmission detector. There is also need for systems and methods for real-time determination of a direction the X-ray beam with respect to the transmission detector and an indication or feedback prompting a user to maneuver the X-ray source so that the X-ray beam may be positioned to strike the transmission detector.

### SUMMARY

The following embodiments and aspects thereof are described and illustrated in conjunction with systems, tools and methods, which are meant to be exemplary and illustrative, and not limiting in scope. The present application discloses numerous embodiments.

In some embodiments, the present specification is directed towards a system for scanning a target object, comprising: a X-ray scanning system having an X-ray source configured to emit a spatially localized X-ray beam onto the target object; a transmission detector positioned such that the target object is positioned between the X-ray scanning system and the transmission detector; a computing device in data communication with the X-ray scanning system and the transmission detector, wherein the computing device comprises a processor and a non-volatile memory storing a plurality of programmatic code which when executed cause the processor to: trigger the X-ray source to generate the X-ray beam; receive digital detection data from the transmission detector; compare the digital detection data to a predetermined value range; and display, in at least one graphical user interface, first data indicative of the X-ray beam striking the transmission detector if the digital detection data is within the value range or display second data indicative of the X-ray beam not striking the transmission detector if the digital detection data is not within the value range.

Optionally, the X-ray scanning system is configured as a handheld scanner.

Optionally, a position of the transmission detector is not fixed relative to the X-ray scanning system.

Optionally, the digital detection data is indicative of a dose rate of X-ray radiation incident on the transmission detector due to the X-ray beam transmitted through and scattered by the target object.

Optionally, the value range of the dose rate is 100 μR/hr to 1000 μR/hr.

Optionally, the digital detection data is indicative of a common bias current of an array of detector elements or pixels of the transmission detector.

Optionally, the value range of the common bias current is 50 nA to 200 nA.

Optionally, the first data is represented by a visual icon, the second data is represented by a visual icon, and wherein the visual icon of the first data is visually different than the icon of the second data.

Optionally, each of the first data and the second data is represented by an auditory indicator and wherein the auditory indicator of the first data is different from the auditory indicator of the second data.

Optionally, a plurality of dosimeters is positioned proximate to the transmission detector.

In some embodiments, the present specification is directed towards a system for scanning a target object, comprising: a X-ray scanning system having an X-ray source configured to emit a spatially localized X-ray beam onto the target object; a transmission detector defined by a plurality of pixels and positioned between the X-ray scanning system and the target object, wherein the transmission detector has a first quadrant region, a second quadrant region, a third quadrant region and a fourth quadrant region, and wherein each of the first, second, third and fourth quadrant regions has an associated subset of pixels of the plurality of pixels; a computing device in data communication with the X-ray scanning system and the transmission detector, wherein the computing device comprises a processor and a non-volatile memory storing a plurality of programmatic code which, when executed, cause the processor to: trigger the X-ray source to generate the X-ray beam; receive, from the transmission detector, first read-out current data from the first quadrant, second read-out current data from the second quadrant, third read-out current data from the third quadrant and fourth read-out current data the fourth quadrant region; sum the first, second, third and fourth read-out current data in order to generate summed read-out current data; compare the summed read-out current data to a predetermined value range; and display, in at least one graphical user interface, first data indicative of the X-ray beam striking the transmission detector or second data indicative of the X-ray beam not striking the transmission detector based on the comparison of the summed read-out current data to the predetermined value range.

Optionally, the X-ray scanning system is configured as a handheld scanner.

Optionally, a position of the transmission detector is not fixed relative to the X-ray scanning system.

Optionally, each of the first, second, third and fourth read-out current data are indicative of an intensity of X-ray radiation incident on the corresponding quadrant region.

Optionally, the value range of the dose rate is 100 μR/hr to 1000 μR/hr.

Optionally, the first data is represented by a visual icon, the second data is represented by a visual icon, and wherein the visual icon of the first data is visually different than the icon of the second data.

Optionally, each of the first data and the second data is represented by an auditory indicator and wherein the auditory indicator of the first data is different from the auditory indicator of the second data.

Optionally, if the summed read-out current data is less than the predetermined value range, the plurality of programmatic code further cause the processor to: determine a maximum read-out current data from the first, second, third and fourth read-out current data; determine a direction of the X-ray beam relative to the first, second, third and/or fourth quadrant regions based on the maximum read-out current data; and display, in the at least one graphical user interface, navigation data indicative of a direction in which the X-ray scanning system should be maneuvered in order for the X-ray beam to be aligned with the transmission detector.

Optionally, the navigation data comprises one or more visual arrows indicative of a direction in which the X-ray scanning system should be maneuvered.

Optionally, a plurality of dosimeters is positioned proximate to the transmission detector.

In some embodiments, the present specification discloses a system for scanning a target object, comprising: a X-ray scanning system having an X-ray source configured to emit a spatially localized X-ray beam onto the target object; a transmission detector positioned such that the target object is positioned between the X-ray scanning system and the transmission detector; a computing device in data communication with the X-ray scanning system and the transmission detector, wherein the computing device comprises a processor and a non-volatile memory storing a plurality of programmatic code which when executed cause the processor to: trigger the X-ray source to generate the X-ray beam; receive digital detection data from the transmission detector; compare the digital detection data to a predetermined threshold; and display, in at least one graphical user interface, first data indicative of the X-ray beam striking the transmission detector if the digital detection data is greater than or equal to the predetermined threshold or display second data indicative of the X-ray beam not striking the transmission detector if the digital detection data is less than the predetermined threshold.

In some other embodiments, the present specification discloses a system for scanning a target object, comprising: a X-ray scanning system having an X-ray source configured to emit a spatially localized X-ray beam onto the target object; a transmission detector defined by a plurality of pixels and positioned between the X-ray scanning system and the target object, wherein the transmission detector has a first quadrant region, a second quadrant region, a third quadrant region and a fourth quadrant region, and wherein each of the first, second, third and fourth quadrant regions has an associated subset of pixels of the plurality of pixels; a computing device in data communication with the X-ray scanning system and the transmission detector, wherein the computing device comprises a processor and a non-volatile memory storing a plurality of programmatic code which, when executed, cause the processor to: trigger the X-ray source to generate the X-ray beam; receive, from the transmission detector, first read-out current data from the first quadrant, second read-out current data from the second quadrant, third read-out current data from the third quadrant and fourth read-out current data the fourth quadrant region; sum the first, second, third and fourth read-out current data in order to generate summed read-out current data; compare the summed read-out current data to a predetermined threshold; and display, in at least one graphical user interface, first data indicative of the X-ray beam striking the transmission detector or second data indicative of the X-ray beam not striking the transmission detector based on the comparison of the summed read-out current data to the predetermined threshold.

In some other embodiments, the present specification discloses a system for scanning a target object, comprising: a portable X-ray scanning system having an X-ray source configured to emit a spatially localized X-ray beam onto the target object; a first arrangement of transmission detectors including a transmission detector panel and first, second, third and fourth dosimeters positioned external to the transmission detector panel, wherein the target object is positioned between the portable X-ray scanning system and the first arrangement of transmission detectors; a computing device in data communication with the portable X-ray scanning system and the first arrangement of transmission detectors, wherein the computing device includes a processor and a non-volatile memory storing a plurality of programmatic code which when executed cause the processor to: trigger the X-ray source to generate the X-ray beam; receive digital detection data from the transmission detector panel, wherein the digital detection data is indicative of a dose rate of radiation incident on the transmission detector panel; compare the digital detection data to a predetermined threshold; and display, in at least one graphical user interface, first data indicative of the X-ray beam striking the transmission detector panel if the digital detection data is greater than or equal to the predetermined threshold or display second data indicative of the X-ray beam not striking the transmission detector panel if the digital detection data is less than the predetermined threshold.

Optionally, if the digital detection data is less than the predetermined threshold, the plurality of programmatic code further cause the processor to: receive first, second, third and fourth dosimeter read-out current data from the first, second, third and fourth dosimeters, respectively; determine a maximum dosimeter read-out current data from the first, second, third and fourth dosimeter read-out current data; determine a direction of the X-ray beam that is skewed towards a dosimeter, of the first, second, third and fourth dosimeters, corresponding to the maximum dosimeter read-out current data; and display, in the at least one graphical user interface, navigation data indicative of a direction in which the portable X-ray scanning system should be maneuvered in order for the X-ray beam to be aligned with the transmission detector panel.

Optionally, the portable X-ray scanning system is configured as a handheld scanner.

Optionally, a position of the first arrangement of transmission detectors is not fixed relative to the portable X-ray scanning system.

Optionally, the first data is represented by a virtual element or visual icon and the second data is represented by a virtual element or visual icon and the virtual element or visual icon of the first data is visually different from the virtual element or visual icon of the first data.

Optionally, each of the first data and the second data is represented by an auditory indicator and wherein the auditory indicator of the first data is different from the auditory indicator of the second data.

Optionally, the navigation data is one or more virtual arrows indicative of a direction in which the portable X-ray scanning system should be maneuvered.

The present specification discloses a system for scanning a target object, comprising: a portable X-ray scanning system having an X-ray source configured to emit a spatially localized X-ray beam onto the target object; a first arrangement of transmission detectors including a transmission detector panel and a plurality of dosimeters, such that the target object is positioned between the portable X-ray scanning system and the first arrangement of transmission detectors; a computing device in data communication with the portable X-ray scanning system and the first arrangement of transmission detectors, wherein the computing device includes a processor and a non-volatile memory storing a plurality of programmatic code which when executed cause the processor to: trigger the X-ray source to generate the X-ray beam; receive digital detection data from the transmission detector panel; compare the digital detection data to a predetermined threshold; and display, in at least one graphical user interface, first data indicative of the X-ray beam striking the transmission detector panel if the digital detection data is greater than or equal to the predetermined threshold or display second data indicative of the X-ray beam not striking the transmission detector panel if the digital detection data is less than the predetermined threshold.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is a front view block diagram showing a scanning environment, in accordance with some embodiments of the present specification;

FIG. 1B is a top view of the scanning environment of FIG. 1A, in accordance with some embodiments of the present specification;

FIG. 2A is a pictorial diagram showing X-ray impinging upon a scintillator-based detector element or pixel, in accordance with some embodiments of the present specification;

FIG. 2B is a schematic electronics diagram of the detector element or pixel of FIG. 2A, in accordance with some embodiments of the present specification;

FIG. 2C is a photomicrograph of the detector element or pixel of FIG. 2A, in accordance with some embodiments of the present specification;

FIG. 3A is a flowchart describing a plurality of exemplary steps of a method of using scan guidance data, in real-time, to determine if the X-ray beam is striking the transmission detector panel, in accordance with some embodiments of the present specification;

FIG. 3B is a flowchart describing a plurality of exemplary steps of a method of using a readout panel signal image to determine if the X-ray beam is striking at least a portion of the transmission detector panel, in accordance with some embodiments of the present specification;

FIG. 3C is a flowchart describing a plurality of exemplary steps of a first method for determining and indicating to a user, in real-time, if at least a portion of a transmission detector panel is exposed to or impinged upon by an X-ray beam, in accordance with some embodiments of the present specification;

FIG. 3D is a flowchart describing a plurality of exemplary steps of a second method for determining and indicating to a user, in real-time, if at least a portion of a transmission detector panel is exposed to or impinged upon by an X-ray beam, in accordance with some embodiments of the present specification;

FIG. 3E is a flowchart describing a plurality of exemplary steps of a first method for determining, in real-time, a direction of an X-ray beam with reference to a transmission detector panel, in accordance with some embodiments of the present specification;

FIG. 3F is a flowchart describing a plurality of exemplary steps of a second method for determining, in real-time, a direction of an X-ray beam with reference to the transmission detector panel, in accordance with some embodiments of the present specification;

FIG. 3G is a flowchart describing a plurality of exemplary steps of a third method for determining, in real-time, a direction of the X-ray beam with reference to the transmission detector panel, in accordance with some embodiments of the present specification;

FIG. 3H is a flowchart describing a plurality of exemplary steps of a fourth method for determining, in real-time, a direction of the X-ray beam with reference to the transmission detector panel, in accordance with some embodiments of the present specification;

FIG. 4 is a graph showing common bias current versus time, for a transmission detector panel, in accordance with some embodiments of the present specification;

FIG. 5 is a block diagram of a transmission detector panel having first, second, third and fourth quadrants, in accordance with some embodiments of the present specification; and

FIG. 6 is an illustration of a scenario showing where a scatter source skews an X-ray beam with respect to a transmission detector panel, in accordance with some embodiments of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module” or “engine” used in this disclosure may refer to computer logic utilized to provide a desired functionality, service or operation by programming or controlling a general purpose processor. Stated differently, in some embodiments, a module or engine implements a plurality of instructions or programmatic code to cause a general purpose processor to perform one or more functions. In various embodiments, a module or engine can be implemented in hardware, firmware, software or any combination thereof. The module or engine may be interchangeably used with unit, logic, logical block, component, or circuit, for example. The module or engine may be the minimum unit, or part thereof, which performs or is configured to perform one or more particular functions.

The term “target object” used in this disclosure may refer to materials such as narcotics, explosives or currency, and objects, such as weapons or people, that are concealed within or behind barriers with an intention that the materials or objects remain undetected by routine or targeted security checks.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

### Overview

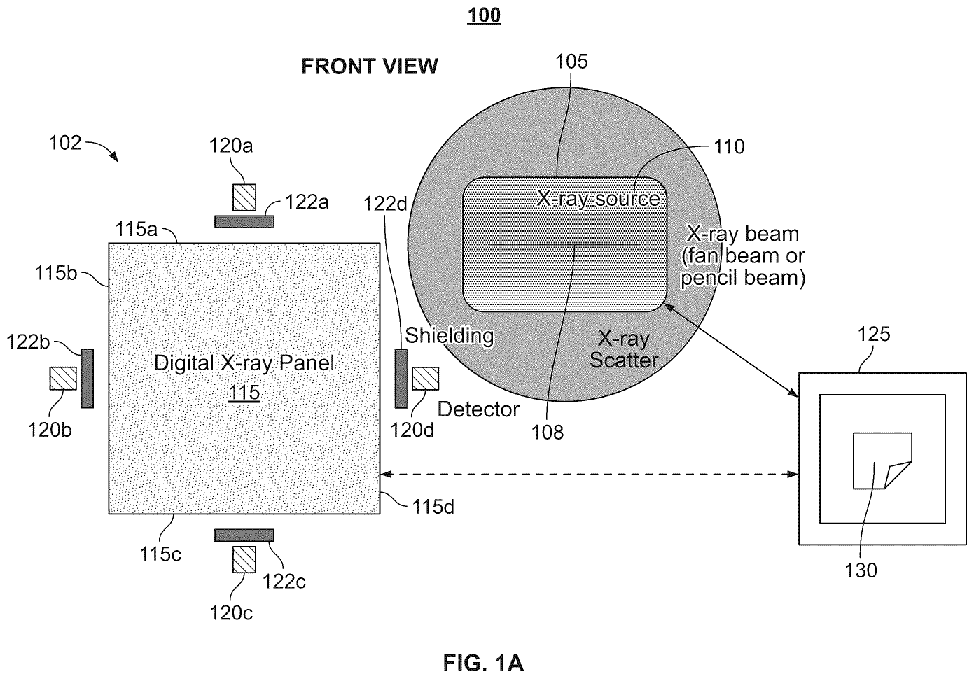

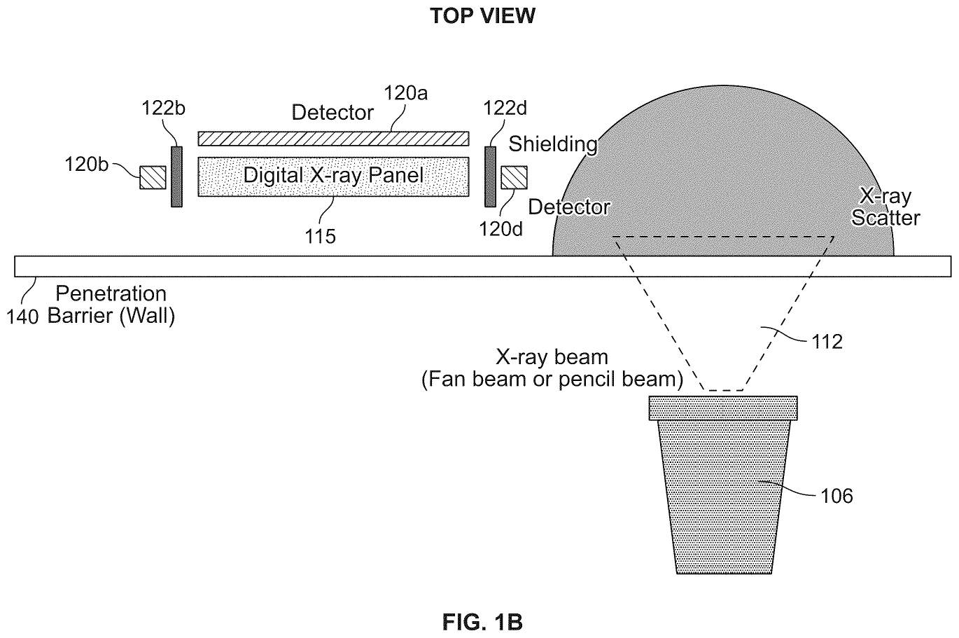

FIG. 1A is a front view block diagram and FIG. 1B is a top view block diagram showing scanning environment 100, in accordance with some embodiments of the present specification. As shown in FIGS. 1A and 1B, scanning environment 100 comprises a portable X-ray scanning system 102 connected, either wired or wirelessly to a first arrangement of transmission detectors including a transmission detector panel 115 and a plurality of dosimeters 120.

In some embodiments, the plurality of dosimeters 120 includes a first dosimeter 120a, a second dosimeter 120b, a third dosimeter 120c, and a fourth dosimeter 120d (collectively referred to by the numeral 120), each of which is positioned external to the transmission detector panel 115. More specifically, in some embodiments, the first dosimeter 120a is positioned proximate a top side 115a of detector panel 115, the second dosimeter 120b is positioned proximate a left side 115b of detector panel 115, the third dosimeter 120c is positioned proximate a bottom side 115c of detector panel 115, and the fourth dosimeter 120d is positioned proximate a right side 115d of detector panel 115.

Each of the plurality of dosimeters 120 has a shield, 122a, 122b, 122c, and 122d, respectively associated therewith (collectively referred to by the numeral 122) positioned between the dosimeter and the transmission detector panel 115. For example, a first shield 122a is positioned between the first dosimeter 120a and the top side 115a, a second shield 122b is positioned between the second dosimeter 120b and the left side 115b, a third shield 122c is positioned between the third dosimeter 120c and the bottom side 115c, and a fourth shield 122d is positioned between the fourth dosimeter 120d and the right side 115d of the transmission detector panel 115. The shields 122a, 122b, 122c, and 122d are formed of an X-ray absorptive material, such as, for example, tungsten or uranium.

In some embodiments, the portable X-ray scanning system 102 may optionally further comprise a second arrangement of at least one X-ray backscatter detector (not shown) positioned on the same side as the X-ray source 110 in order to detect signals that are backscattered from a target object 140.

In embodiments, the portable X-ray scanning system 102 comprises an X-ray source 110 (such as, for example, an X-ray tube) that is configured to emit an X-ray beam 112. In embodiments, the X-ray beam 112 is spatially localized. It should be noted that “spatially localized” refers to an X-ray beam that is tightly focused, shaped, or restricted to a particular area or direction. Thus, the X-ray source emits radiation in a controlled geometry (e.g., a pencil beam, fan beam, or cone beam) that specifically targets a small region or path rather than illuminating a large, diffuse area.

In some embodiments, the portable X-ray scanning system 102 is configured as a handheld scanner having a housing or enclosure 106 (that has a handle for holding and maneuvering the handheld scanner) for accommodating the X-ray source 110 that is configured to emit the X-ray beam 112 through an opening or aperture 108. The opening 108 is of a size and a thickness such that it can act as a collimator in forming or shaping and limiting the X-ray radiation, emitted from the X-ray source 110, into a shaped beam of X-rays 112. In some embodiments, the X-ray beam 112 is shaped into a fan beam, cone beam or a pencil beam. In an embodiment, X-ray beam 112 is preferably a pencil beam. In embodiments where the portable X-ray scanning system 102 is configured as a handheld scanner, the second arrangement of at least one X-ray backscatter detector is positioned adjacent to and behind a front surface 105 of the housing or enclosure 106 to maximize the detected backscatter signal.

In some embodiments, the portable X-ray scanning system 102 is configured as a mobile inspection vehicle such that the housing 106 with the enclosed X-ray source 110 is mounted in the mobile vehicle. In such embodiments, the second arrangement of at least one X-ray backscatter detector is mounted on a side of the mobile vehicle through which the X-ray beam 112 is projected onto the target object 140 for scanning.

In embodiments, a computing device 125 is in data communication with the portable X-ray scanning system 102 as well as the first arrangement of transmission detectors and is used to control the operation of the X-ray source 110 and the routing, transmission, processing, and/or storage of various detection data. In some embodiments, such as those of the handheld scanner configuration, the computing device 125 is physically coupled to the housing 106 and is adapted to control an operation of the X-ray source 110. In some embodiments, such as those of the mobile inspection vehicle, the computing device 125 is positioned remotely or within the vehicle and not physically coupled to the housing 106.

During scanning, the target object 140 is positioned between the portable X-ray scanning system 102 and the first arrangement of transmission detectors. In accordance with some aspects of the present specification, the position of the first arrangement of transmission detectors is not fixed relative to the portable X-ray scanning system 102. Stated differently, a user may conveniently move and position the first arrangement of transmission detectors where desired on a first side of the target object 140 while the portable X-ray scanning system 102 is positioned on a second side, opposite to the first side, of the target object 140. In doing so, it should be noted that the first arrangement of transmission detectors may not necessarily be positioned in a line of sight of the X-ray beam 112.

### Detectors

In various embodiments, the transmission detector panel 115 and each of the plurality of dosimeters 120 includes a plurality of detector modules and associated data acquisition systems. In some embodiments, each of the plurality of detector modules includes a plurality of detector elements or pixels.

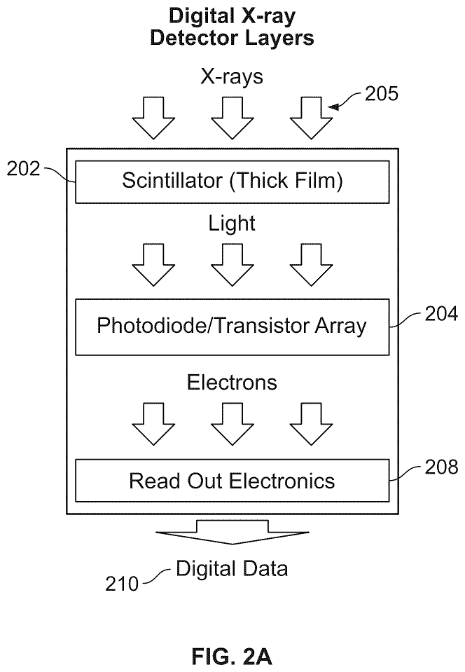

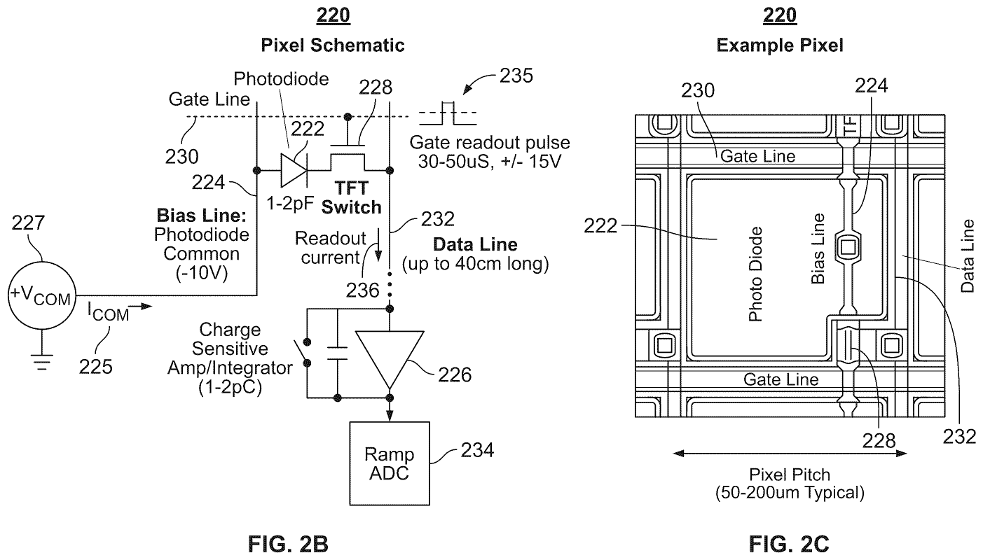

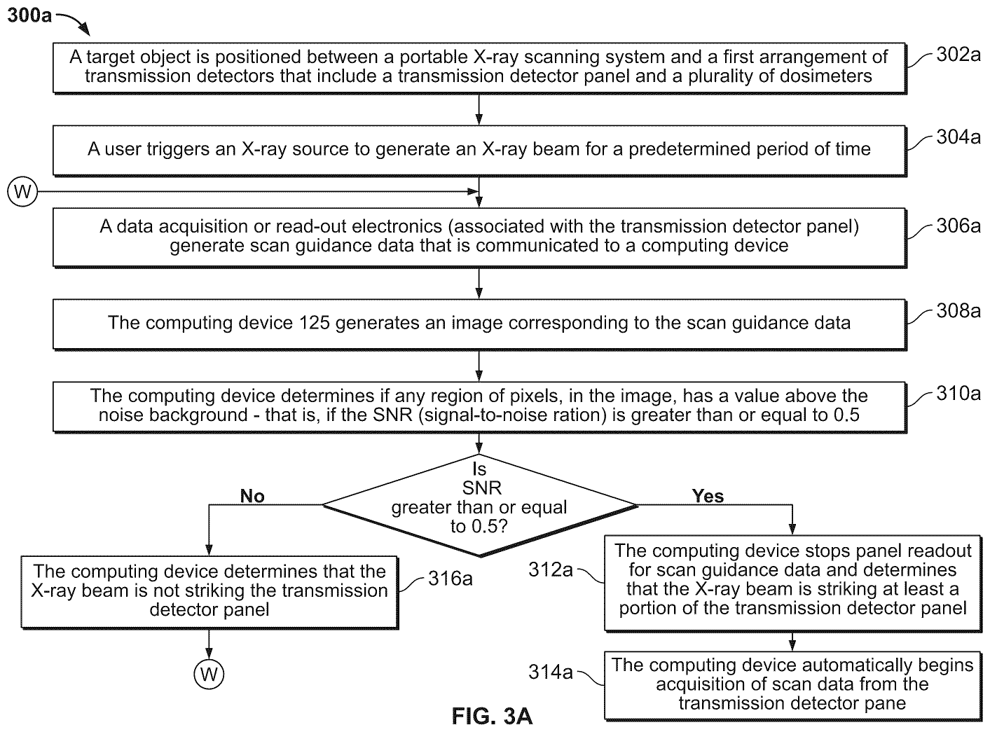

As shown in FIG. 2A, in some embodiments, each detector element or pixel, of the transmission detector panel 115 and the plurality of dosimeters 120, is scintillator-based and includes a scintillator 202 and a light sensor 204 connected or integrated into an integrated circuit. In some embodiments, the scintillator 202 is formed of a scintillator crystal material characterized by having rapid decay time of the light photons generated within the scintillator 202 in response to the impinging X-ray photons 205. In some embodiments, the rapid decay time is about 1 ms. In various embodiments, the scintillator crystal may be of inorganic or organic material. Inorganic scintillators may be of material such as, but not limited to, CsI(Tl), NaI, BGO, LaBr3, CLLBC, CeBr3, LYSO, LSO, GSO, or YAP. In some additional embodiments, scintillator phosphors may also be used including Gd₂O₂S(Tb, Pr, Eu), BaFCl(Eu). Organic scintillators could be single crystal, liquid, plastic, and organic glass. Common organic scintillators are based on PVT (polyvinyl toluene).

In various embodiments, the light sensor 204 operates as an optical conversion stage for detection of the light photons generated within the scintillator 202. In some embodiments, the optical conversion stage includes a photodiode, a PMT (photomultiplier tube), a SiPM (Silicon Photo-multiplier), a SDD (silicon drift detector), or an APD (avalanche photo diode).

At a first stage, the scintillator 202 receives impinging X-ray photons 205 and in response generates corresponding light photons. The light photons traverse the scintillator 202 and are received by the light sensor 204, at a second stage, which converts the light photons into corresponding analog electrical signals. The generated analog signals are transported to a coupled data acquisition or read-out electronics 208, in a third stage, where the analog signals are converted to digital detection data 210.

In some embodiments, the scintillator 202 is optically coupled, in optical contact or in physical communication with a wavelength-shifting sheet (WSS), which shifts the wavelength of the light photons absorbed from the scintillator 202. The wavelength shifting sheet is coupled to a wavelength shifting fiber or sheet at the edge of the wavelength shifting sheet that is configured to collect a plurality of first shifted rays. The rays collected from the edge are transmitted through to the light sensor or optical conversion stage 204 for detection which, in turn, transmits the detected analog signals to the data acquisition stage or read-out electronics 208 where the analog signals are converted to the digital detection data 210.

U.S. Pat. Nos. 9,285,488, 9,658,343, and 10,209,372 are herein incorporated by reference in their entirety. In addition, U.S. Pat. Nos. 10,670,740 and 11,579,327 and United States Patent Publication No. 20230221457 are herein incorporated by reference in their entirety. In addition, U.S. Pat. Nos. 10,830,911 and 11,525,930 and United States Patent Publication No. 20230152475 are herein incorporated by reference in their entirety. In addition, U.S. Pat. Nos. 10,168,445, 10,901,113, 11,300,703 and 11,561,320 and United States Patent Publication No. 20230204812 are herein incorporated by reference in their entirety.

Alternatively, in some embodiments, each detector element or pixel, of the transmission detector panel 115 and the plurality of dosimeters 120, is a semiconductor that, in response to incoming X-ray photons, generates an electrical signal that is collected by associated data acquisition or read-out electronics that typically perform signal amplification, discrimination, and counting/analog-to-digital conversion (ADC) to output digital detection data (similar to the digital detection data 210).

FIG. 2B is a schematic electronics flow diagram of a detector element or pixel 220 of the scintillator-based detector of FIG. 2A while FIG. 2C is a photomicrograph of the detector element or pixel 220, in accordance with some embodiments of the present specification. Referring now to FIGS. 2B and 2C, detector element 220 comprises a photodiode 222 that is reverse-biased through a common bias line 224, whereby signal charges are accumulated and stored in the photodiode 222 during a scanning cycle. The integrated charge signal is transferred and converted to a voltage signal through a charge amplifier 226 when a TFT (Thin Film Transistor) 228 is turned on. The TFT 228 is controlled by its associated gate line 230. The common bias line 224 has a diode common voltage 227 and an associated common bias current 225. When a clock pulse generator of the gate driver sends a gate read-out pulse 235 to the pixel 220, signal charges or read-out current 236 from the pixel 220 are read out directly through a data line 232 and amplified and converted into voltage signals by the charge integrating amplifier 226. The voltage signals are then converted into digital detection data (similar to the digital detection data 210) through an analog-to-digital converter (ADC) 234.

In embodiments, the read-out through the data line 232 is performed at a speed or frequency that is sufficiently high enough to enable the computing device 125 to provide rapid, real-time feedback to the user for maneuvering the portable X-ray scanning system 102. In some embodiments, the read-out frequency ranges from 5 Hz to 30 Hz. In some embodiments, a preferred read-out frequency is 20 Hz. It should be further appreciated that if the X-ray beam 112 strikes a low scatter target object 140 the read-out signals may be small and noisy. In such cases, longer and slower accumulation times (for read-out) will reduce the noise and improve the signal-to-noise ratio (SNR). A low scatter target object 140 may include any high atomic number material with a Z of approximately 18 or greater, such as a metal, and in particular as an example, steel. Conversely, a high scatter object includes any low atomic number material with Z<18, such as, for example, a polyethylene plastic.

The readout of transmission detector panel 115 (panel readout) will now be discussed in detail. In some embodiments, the transmission detector panel 115 initially works in an accumulation mode when a trigger (such as, for example, a button), associated with the portable X-ray scanning system 102, is held in a depressed or activated state. Holding the trigger in a depressed or activated state causes the X-ray beam 112 to be generated in order to strike the transmission detector panel 115. During the accumulation mode all TFTs (such as, the TFT 228 of FIG. 2B) of an array of pixels of the transmission detector panel 115, are held in an off-state while the transmission detector panel is exposed to the X-ray beam 112. During the accumulation mode, there is no digital readout data directly from the transmission detector panel 115 while charge is accumulated in the array of pixels. When the trigger is released and the X-ray beam 112 is shut off, the transmission detector panel 115 is read out by sequentially energizing each row of the TFT's and converting the accumulated voltage signals into digital detection data. During the time when the TFT's are in the off state, there is no dose data generated by the transmission detector panel 115. Reading out the panel 115 removes the charge stored in the pixels, which is converted to digital detection data (similar to the digital detection data 210).

The transmission detector panel 115 common bias current readout will now be described in detail. During the time when the panel 115 is in accumulation mode, it cannot generate data to indicate to the user whether the X-ray beam 112 is striking the panel 115. However, during the accumulation mode, the common bias current (such as, the common bias current 225 of FIG. 2B) is a direct measure of the total dose rate being delivered to the panel 115 and can be made during the accumulation mode. Reading the common bias current does not have any effect on the signal being accumulated in the array of pixels. In some embodiments, the common bias current can be used to detect whether the X-ray beam 112 is striking the panel 115 directly and/or when the common bias current from the entire panel 115 is accumulated. Alternately, in some embodiments, the common plane can be split into, for example, four quadrants and the direction of the X-ray beam 112 is inferred from the currents of each quadrant (as discussed later in this specification).

Referring back to FIG. 1A, and 1B, the transmission detector panel 115 is thus configured to generate first digital detection data, the first dosimeter 120a is configured to generate second digital detection data, the second dosimeter 120b is configured to generate third digital detection data, the third dosimeter 120c is configured to generate fourth digital detection data and the fourth dosimeter 120d is configured to generate fifth digital detection data. In some embodiments, the first digital detection data is indicative of a dose rate of X-ray radiation incident on the transmission detector panel 115 due to the X-ray beam 112 transmitted through and scattered by the target object 140.

In some embodiments, the transmission detector panel 115 generates read-out current data associated with the entire transmission detector panel 115. In some embodiments, the read-out current data is indicative of an intensity or strength of X-ray radiation incident on the transmission detector panel 115 due to the X-ray beam 112 transmitted through and scattered by the target object 140.

In some embodiments, the transmission detector panel 115 generates one or more read-out current data associated with one or more regions, areas or portions of the transmission detector panel 115. In some embodiments, the one or more read-out current data is indicative of an intensity or strength of X-ray radiation incident on one or more regions, areas or portions of the transmission detector panel 115 due to the X-ray beam 112 transmitted through and scattered by the target object 140.

In some embodiments, each of the second digital detection data, third digital detection data, fourth digital detection data and fifth digital detection data corresponds to read-out current data indicative of intensity or strength of X-ray radiation incident on respective first dosimeter 120a, second dosimeter 120b, third dosimeter 120c, and fourth dosimeter 120d due to the X-ray beam 112 transmitted through and scattered by the target object 140.

In various embodiments, various detection data, from the transmission detector panel 115 and the plurality of dosimeters 120, is communicated to the computing device 125 wirelessly or through wired connections.

### Exposure Feedback Module or Engine 130

In embodiments, the computing device 125 is configured to implement an exposure feedback module or engine 130. The exposure feedback module or engine 130 includes a plurality of instructions of programmatic code which when executed by a processor of the computing device 125, the computing device 125 is configured to, in real-time, a) determine if the X-ray beam 112, transmitted through and scattered by the target object 140, is striking at least a portion of the transmission detector panel 115 and/or b) determine a direction of the X-ray beam 112, transmitted through and scattered by the target object 140, with reference to the transmission detector panel 115.

The exposure feedback module or engine 130 further includes a plurality of instructions of programmatic code which when executed by the processor of the computing device 125, the computing device 125 is configured to generate at least one graphical user interface (GUI) to display, in real-time, data indicative of whether the X-ray beam 112, transmitted through and scattered by the target object 140, is striking at least a portion of the transmission panel 115 and/or display, in real-time, data indicative of a direction in which the portable X-ray scanning system 102 (or the X-ray source 110) should be moved with reference to the transmission panel 115 (based on the determined direction of the transmitted X-ray beam 112) to ensure that the X-ray beam 112, transmitted through and scattered by the target object 140, hits at least a portion of the transmission panel 115.

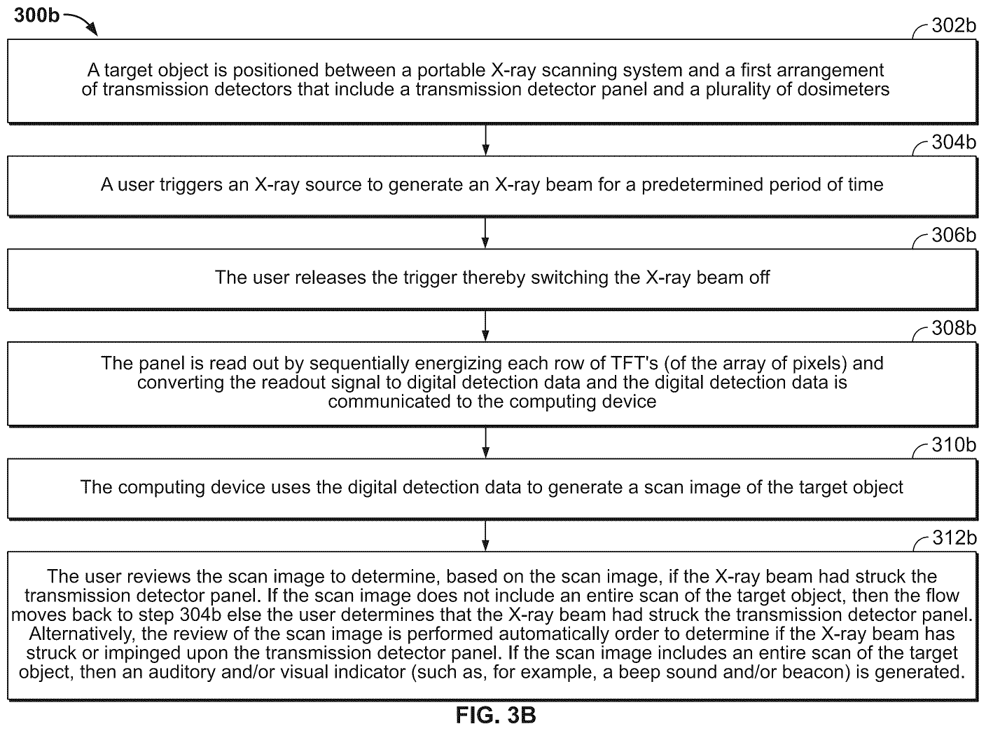

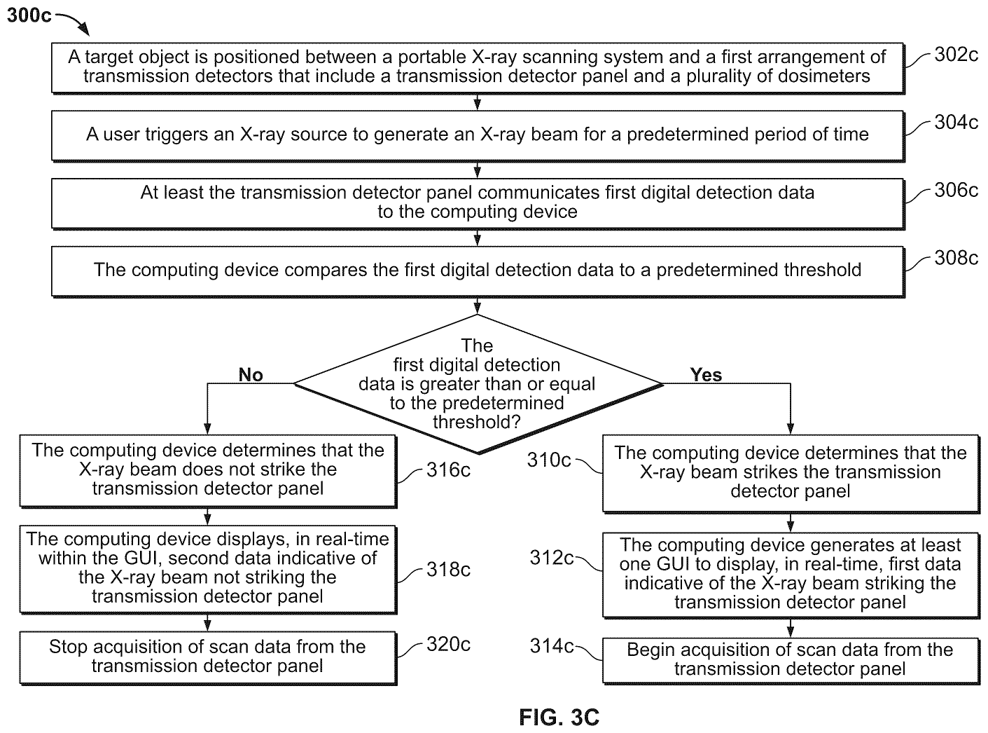

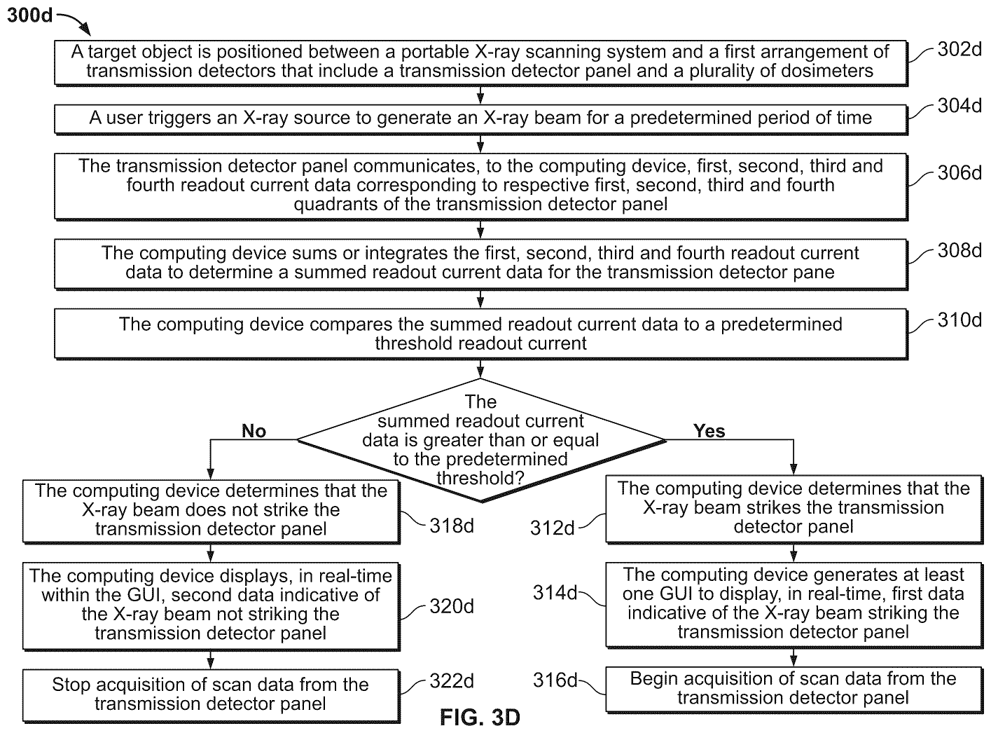

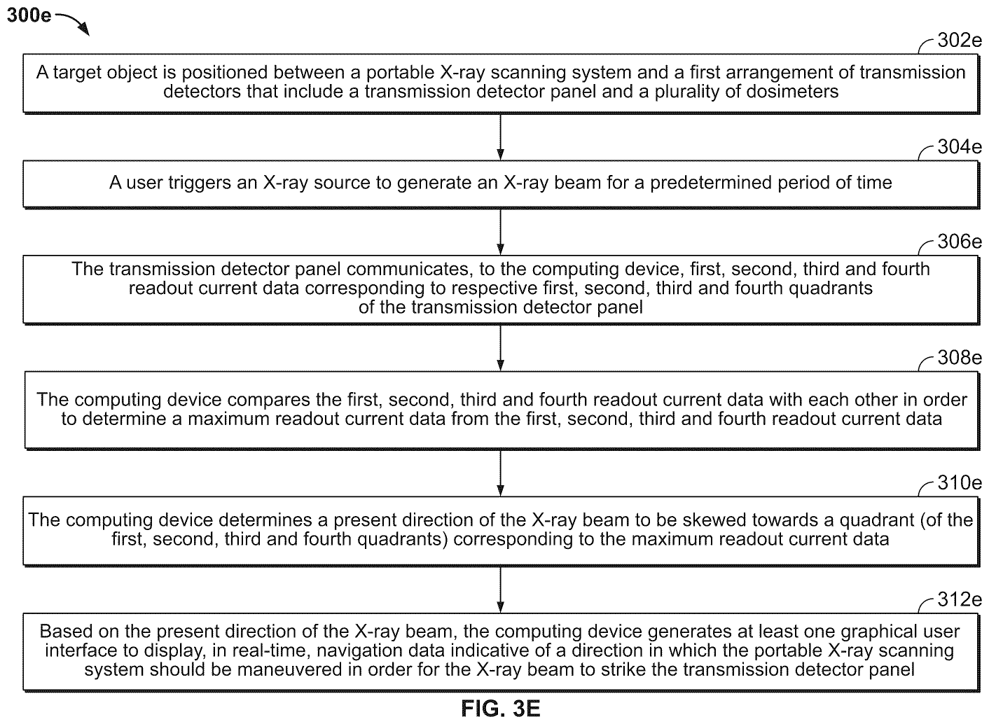

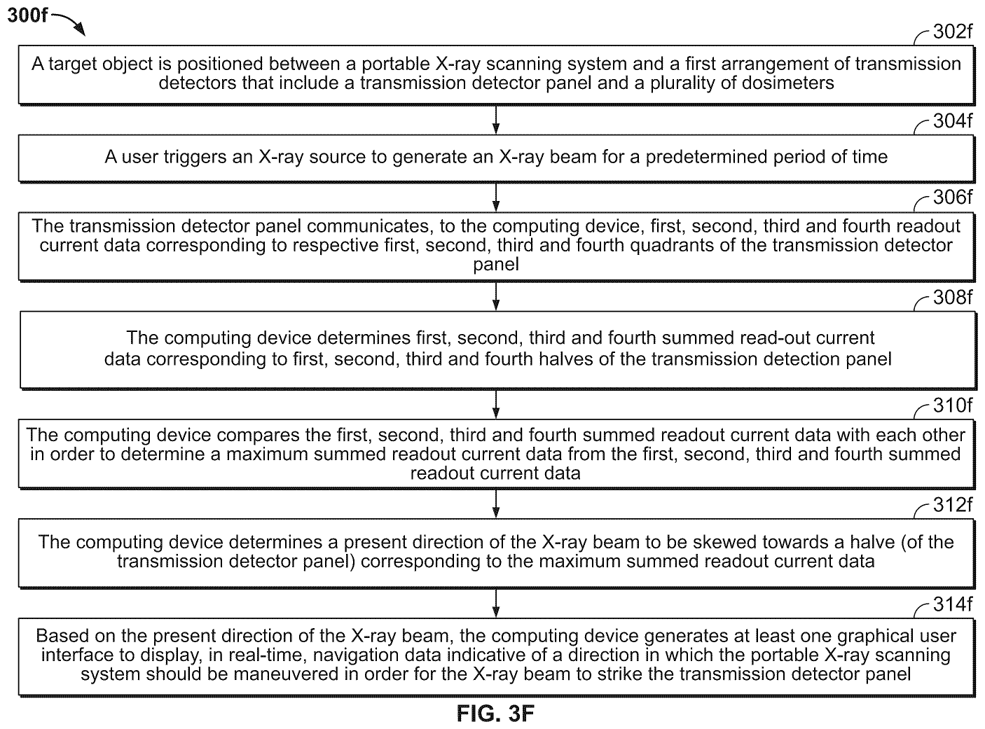

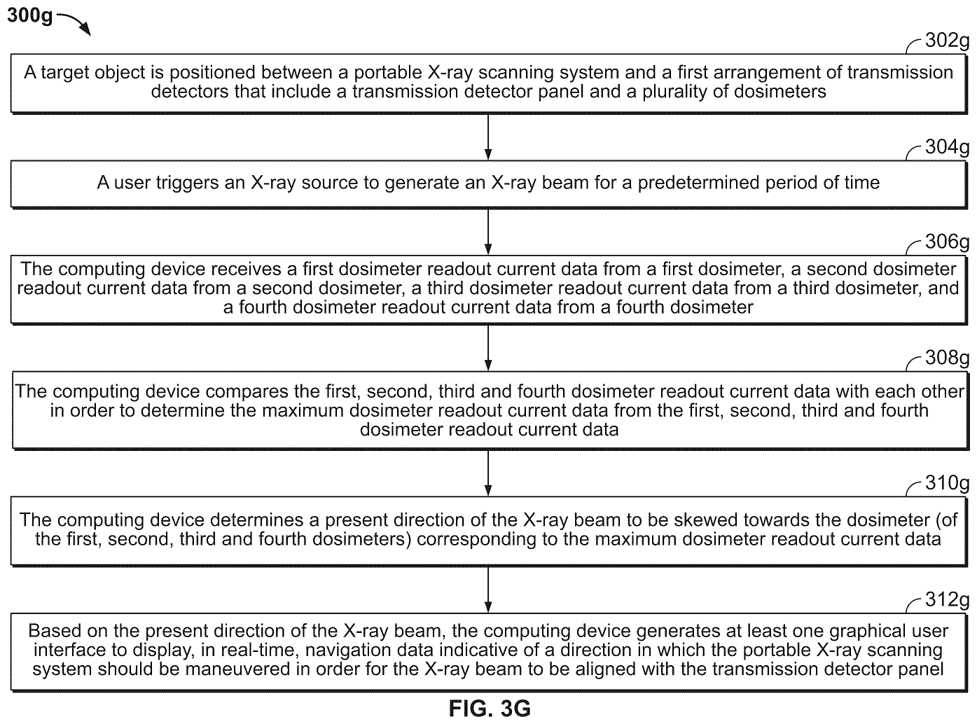

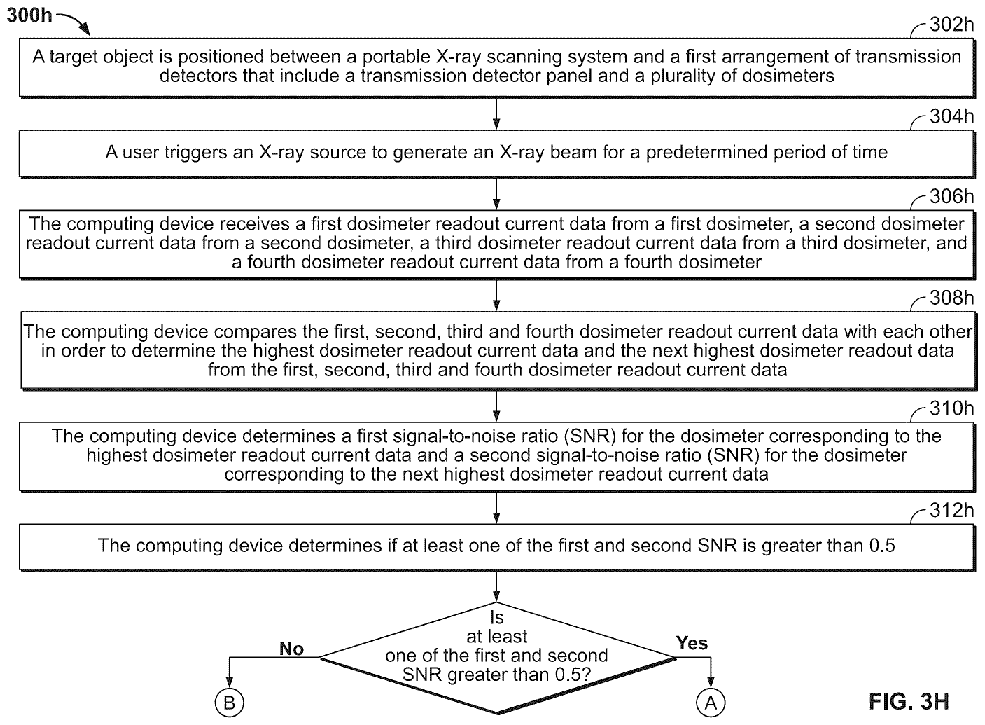

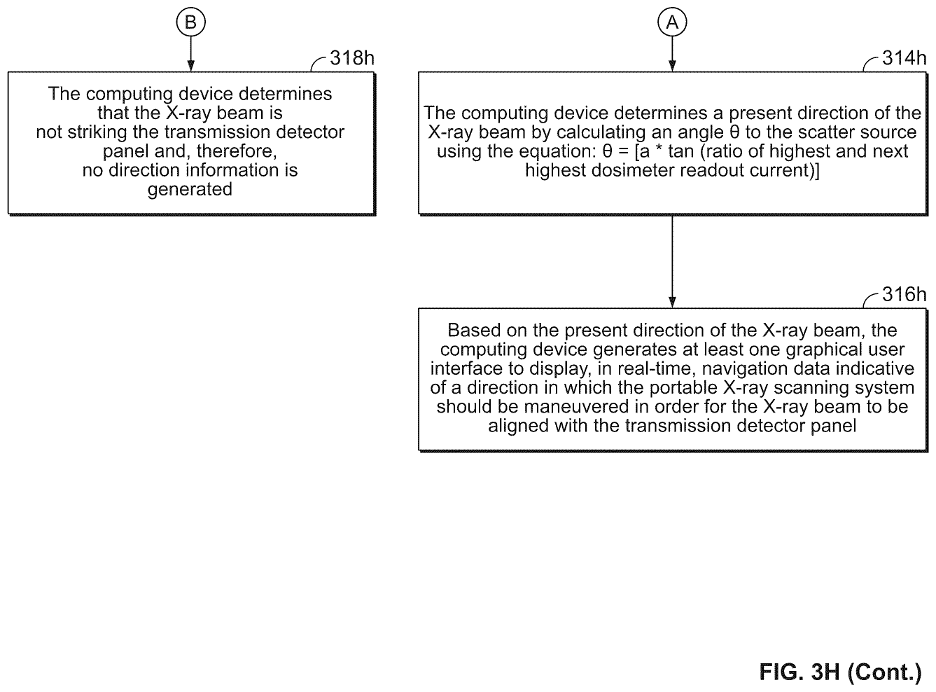

A First Method of Determining if the X-Ray Beam 112 is Striking the Transmission Detector Panel 115 FIG. 3A is a flowchart describing a plurality of steps of a method 300a of using scan guidance data, in real-time, to determine if the X-ray beam 112 is striking the transmission detector panel 115, in accordance with some embodiments of the present specification. The computing device 125 is configured by the exposure feedback module or engine 130 to implement the method 300a.

Referring now to FIGS. 1A, 1B, 2A and 3A, at step 302a the target object 140 is positioned between the portable X-ray scanning system 102 and the first arrangement of transmission detectors that includes the transmission detector panel 115 and the plurality of dosimeters 120. In some embodiments, the first arrangement of transmission detectors and the portable X-ray scanning system 102 may not be in visual range of one another.

At step 304a, the user triggers the X-ray source 110 to generate the X-ray beam 112 for a predetermined period of time. In some embodiments, the X-ray source 110 is triggered by, for example, depressing an actuator or trigger (such as a button) of the portable X-ray scanning system 102. The actuator may be held in a depressed state for the predetermined period of time. In some embodiments, the predetermined period of time varies from 5 to 30 seconds.

At step 306a, the data acquisition or read-out electronics 208 generate scan guidance data that is communicated to the computing device 125. In some embodiments, the read-out frequency ranges from 5 Hz to 30 Hz. In some embodiments, the scan guidance data is indicative of common bias current for the transmission detector panel 115. The scan guidance data is used to guide the user in terms of whether the X-ray beam 112 is striking any portion of the transmission detector panel 115 or not. It should be appreciated that the detection of the X-ray beam 112 striking the transmission detector panel 115 does not interfere with the panel readout such that the panel can continue to collect signals without being readout.

At step 308a, the computing device 125 generates an image corresponding to the scan guidance data.

At step 310a, the computing device 125 determines if any region of pixels, in the image, has a value above the noise background - that is, if the SNR (signal-to-noise ration) is greater than or equal to 0.5.

If the SNR is greater than or equal to 0.5, then, at step 312a, the computing device 125 stops panel readout for scan guidance data and determines that the X-ray beam 112 is striking at least a portion of the transmission detector panel 115. Consequently, at step 314a, the computing device 125 automatically begins acquisition of scan data from the transmission detector panel 115.

In some embodiments, at step 312a, the computing device 125 further generates at least one graphical user interface to display, in real-time, first data indicative of the X-ray beam 112 striking the transmission detector panel 115. In some embodiments, the first data is a virtual element or visual icon such as, for example, a 2D or 3D shape such as a circle, square, any other quadrilateral shape or an icon such as a thumbs-up sign. In embodiments, the virtual element or visual icon is color-coded such as, for example, in green color. Alternatively, or additionally, the first data may include a textual message conveying that the X-ray beam 112 is striking the transmission detector panel 115 and that the system will begin acquiring scan data.

Alternatively, or additionally, in some embodiments, the computing device 125 may generate a sound, such as a beep, indicating that the X-ray beam 112 striking the transmission detector panel 115. Still alternatively, or additionally, in some embodiments, the computing device 125 may generate a visual indicator such as a beacon of light of, for example, a green color (indicating that the X-ray beam 112 is striking the transmission detector panel 115) on an external surface of the X-ray scanning system 102. For example, when the portable X-ray scanning system 102 is a handheld device, the beacon of light may be generated on the external surface of a body or housing of the handheld device.

If the SNR is less than 0.5, then, at step 316a, the computing device 125 determines that the X-ray beam 112 is not striking the transmission detector panel 115 and the flow moves back to step 306a for continuing to generate scan guidance data.

Additionally, the computing device displays, in real-time within the at least one graphical user interface, second data indicative that the X-ray beam 112 is not striking the transmission detector panel 115. In some embodiments, the second data is a virtual element or visual icon such as, for example, a 2D or 3D shape such as a circle, square, any other quadrilateral shape or an icon such as a thumbs-down sign. In embodiments, the virtual element or visual icon may be color-coded such as, for example in red color. Alternatively, or additionally, the second data may include a textual message conveying that the X-ray beam 112 is not striking the transmission detector panel 115 and that the user must align the portable X-ray scanning system 102 and/or the transmission detector panel 115 in order for the system to begin acquiring scan data. In embodiments, the visual element or visual icon of the first data is visually different from the virtual element or visual icon of the second data. In some embodiments, visually different may be defined as being of a different dimension, shape or color.

Still alternatively, or additionally, in some embodiments, the computing device 125 may generate a visual indicator such as a beacon of light of, for example, a red color (indicating that X-ray beam 112 is not striking the transmission detector panel 115) on an external surface of the portable X-ray scanning system 102. For example, when the portable X-ray scanning system 102 is a handheld device, the beacon of light may be generated on the external surface of a body or housing of the handheld device.

### A Second Method of Determining if the X-ray Beam 112 Is Striking the Transmission Detector Panel 115

FIG. 3B is a flowchart describing a plurality of steps of a method 300b of using a readout panel signal image to determine if the X-ray beam 112 is striking at least a portion of the transmission detector panel 115, in accordance with some embodiments of the present specification. The computing device 125 is configured by the exposure feedback module or engine 130 to implement the method 300b.

Referring now to FIGS. 1A, 1B and 3B, at step 302b the target object 140 is positioned between the portable X-ray scanning system 102 and the first arrangement of transmission detectors that includes the transmission detector panel 115 and the plurality of dosimeters 120. In some embodiments, the first arrangement of transmission detectors and the portable X-ray scanning system 102 may not be in visual range of one another.

At step 304b, the user triggers the X-ray source 110 to generate the X-ray beam 112 for a predetermined period of time. In some embodiments, the X-ray source 110 is triggered by, for example, depressing an actuator or trigger (such as a button) of the portable X-ray scanning system 102. The actuator may be held in a depressed state for the predetermined period of time. In some embodiments, the predetermined period of time varies from 5 to 30 seconds.

In embodiments, the transmission detector panel 115 is in accumulation mode by holding all TFTs (of the array of pixels) in the off state while the X-ray beam 112 is on.

At step 306b, the user releases the trigger thereby switching the X-ray beam 112 off.

At step 308b, the panel 115 is read out by sequentially energizing each row of the TFT's (of the array of pixels) and converting the readout signal to digital detection data and the digital detection data is communicated to the computing device 125.

At step 310b, the computing device 125 uses the digital detection data to generate a scan image of the target object 140.

At step 312b, the user reviews the scan image to determine, based on the scan image, if the X-ray beam 112 has struck or impinged upon the transmission detector panel 115. If the scan image does not include a region greater than a threshold size (1 cm×1 cm) with an SNR>0.5, then the flow moves back to step 304b until the user determines that the X-ray beam 112 has struck or impinged upon the transmission detector panel 115. Alternatively, in some embodiments, the review of the scan image is performed automatically by the exposure feedback module or engine 130 in order to determine if the X-ray beam 112 has struck or impinged upon the transmission detector panel 115. If the scan image includes a region greater than a threshold size (1 cm×1 cm) with an SNR>0.5, then an auditory and/or visual feedback indicator (such as, for example, a beep sound and/or beacon) is generated. It should be noted that, in embodiments, a direct beam dose to the panel is sufficient and it is not required to expose an entire scan of the object of interest.

### A Third Method of Determining if the X-Ray Beam 112 is Striking the Transmission Detector Panel 115

In some embodiments, the exposure feedback module or engine 130 is configured to process first digital detection data received by the computing device 125 from the transmission detector panel 115 in order to determine and indicate to a user, in real-time, if at least a portion of the transmission detector panel 115 is being impinged upon by the X-ray beam 112 (transmitted through and scattered by the target object 140), wherein the first digital detection data is indicative of a total X-ray radiation dose rate received by the transmission detector panel 115. In some embodiments, the total X-ray radiation dose rate is determined by measuring the common bias current in an array of pixels of the entire transmission detector panel 115. Thus, the first digital detection data may either be indicative of the X-ray radiation dose rate or the common bias current.

FIG. 3C is a flowchart describing a plurality of exemplary steps of a first method for determining and indicating to a user, in real-time, if at least a portion of a transmission detector panel 115 is exposed to or impinged upon by an X-ray beam 112, after transmission through and scattered by a target object 140, in accordance with some embodiments of the present specification. The computing device 125 is configured by the exposure feedback module or engine 130 to implement the method 300c.

Referring now to FIGS. 1A, 1B and 3C, at step 302c the target object 140 is positioned between the portable X-ray scanning system 102 and the first arrangement of transmission detectors that includes the transmission detector panel 115 and the plurality of dosimeters 120. In some embodiments, the first arrangement of transmission detectors and the portable X-ray scanning system 102 may not be in visual range of one another.

At step 304c, a user triggers the X-ray source 110 to generate the X-ray beam 112 for a predetermined period of time. In some embodiments, the X-ray source 110 is triggered by, for example, depressing an actuator or trigger (such as a button) of the portable X-ray scanning system 102. The actuator may be held in a depressed state for the predetermined period of time. In some embodiments, the predetermined period of time varies from 5 to 30 seconds.

At step 306c, at least the transmission detector panel 115 communicates the first digital detection data to the computing device 125. In some embodiments, the first digital detection data is indicative of a total dose rate of X-ray radiation incident on the transmission detector panel 115 due to the X-ray beam 112 transmitted through and scattered by the target object 140. In some embodiments, the first digital detection data is indicative of a common bias current (that is, the common bias current 225 of FIG. 2B) of an array of detector elements or pixels of the transmission detector panel 115.

At step 308c, the computing device 125 compares the first digital detection data to a predetermined value range. In some embodiments, the value range is greater than or equal to a predetermined threshold dose rate. In some embodiments, the value range is greater than or equal to a predetermined threshold dose rate, or in absolute terms, 100 μR/hr to 1000 μR/hr.In some embodiments, the dose rate ranges from 100 μR/hr to 1000 μR/hr, and preferably ranges from 100 μR/hr to 200 μR/hr. In some embodiments, the dose rate is 1 mR/hour.

In some embodiments, the predetermined value range is representative of the common bias current of the array of detector elements or pixels of the transmission detector panel 115. In some embodiments, the value range is greater than or equal to a predetermined threshold common bias current. In some embodiments, the value range is greater than or equal to a predetermined threshold common bias current, or ranges from 50 nA to 200 nA, and preferably, ranges from 50 nA to 100 nA. In some embodiments, the common bias current is about 100 nA.

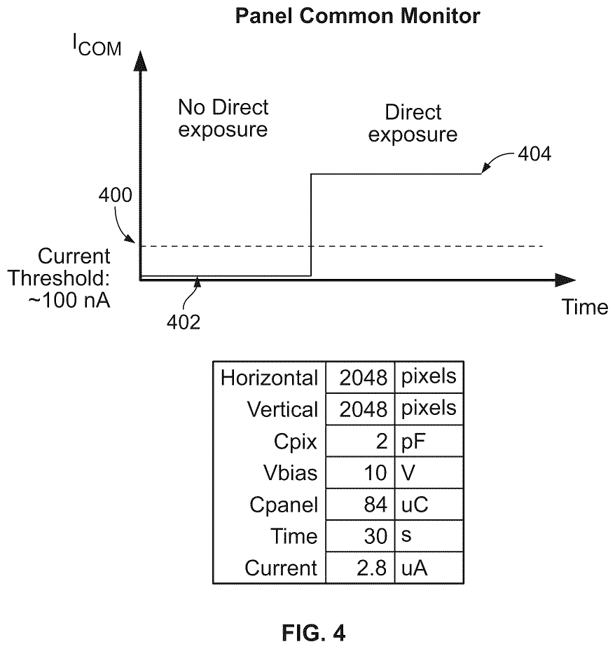

FIG. 4 is a graph showing common bias current versus time, for the transmission detector panel 115, in accordance with some embodiments of the present specification. As shown, if a first common bias current 402 is below a threshold 400, it is indicative of the transmission detector panel 115 not being exposed to the X-ray beam 112. However, if a second common bias current 404 is above the threshold 400, it is indicative of the transmission detector panel 115 being exposed to the X-ray beam 112.

If the first digital detection data is greater than or equal to the predetermined threshold, at step 310c, the computing device 125 determines that the transmission detector panel is exposed to, impinged upon, or struck by X-ray beam 112, transmitted through and scattered by the target object 140. As a result, at step 312c, the computing device 125 generates at least one graphical user interface to display, in real-time, first data indicative of the X-ray beam 112 striking the transmission detector panel 115. In some embodiments, the first data is a virtual element or visual icon such as, for example, a 2D or 3D shape such as a circle, square, any other quadrilateral shape or an icon such as a thumbs-up sign. In embodiments, first data virtual element or visual icon may be color-coded such as, for example, in green color. Alternatively, or additionally, the first data may include a textual message conveying that the X-ray beam 112 is striking the transmission detector panel 115 and that the system will begin acquiring scan data.

Alternatively, or additionally, in some embodiments, the computing device 125 may generate a sound or auditory indicator, such as a beep, indicative of the X-ray beam 112 striking the transmission detector panel 115. Still alternatively, or additionally, in some embodiments, the computing device 125 may generate a visual indicator, such as a beacon of light of, for example, a green color (indicative of that the X-ray beam 112 is striking the transmission detector panel 115) on an external surface of the X-ray scanning system 102. For example, when the portable X-ray scanning system 102 is a handheld device, the beacon of light may be generated on the external surface of a body or housing of the handheld device.

Thereafter, at step 314c, the computing device 125 automatically begins acquisition of scan data from the transmission detector panel 115.

However, if the first digital detection data is less than the predetermined threshold, at step 316c, the computing device 125 determines that the transmission detector panel 115 is not exposed to, impinged upon, or struck by X-ray beam 112, transmitted through and scattered by the target object 140. As a result, at step 318c, the computing device displays, in real-time within the at least one graphical user interface, second data indicative of the X-ray beam 112 not striking the transmission detector panel 115. In some embodiments, the second data is a virtual element or visual icon such as, for example, a 2D or 3D shape such as a circle, square, any other quadrilateral shape or an icon such as a thumbs-down sign. In embodiments, the virtual element or visual icon representative of the second data may be color-coded such as, for example, in red color. Alternatively, or additionally, the second data may include a textual message conveying that the X-ray beam 112 is not striking the transmission detector panel 115 and that the user must align the portable X-ray scanning system 102 and/or the transmission detector panel 115 in order for the system to begin acquiring scan data.

Still alternatively, or additionally, in some embodiments, the computing device 125 may generate a visual indicator such as a beacon of light of, for example, a red color (indicating that the X-ray beam 112 is not striking the transmission detector panel 115) on an external surface of the X-ray scanning system 102. For example, when the portable X-ray scanning system 102 is a handheld device, the beacon of light may be generated on the external surface of a body or housing of the handheld device.

Thereafter, at step 320c, the computing device stops acquiring scan data from the transmission detector panel 115 until it is confirmed that the X-ray beam 112 is striking at least a portion of the transmission detector panel 115.

### A Fourth Method of Determining if the X-ray Beam 112 is Striking the Transmission Detector Panel 115

In some embodiments, the transmission detector panel 115 is divided into a predefined plurality of regions, sectors or areas. Each of the predefined plurality of regions, sectors or areas has an associated subset of detector elements or pixels of the plurality of detector elements or pixels of the transmission detector panel 115. In various embodiments, the predefined plurality of regions, sectors or areas ranges from four to eight.

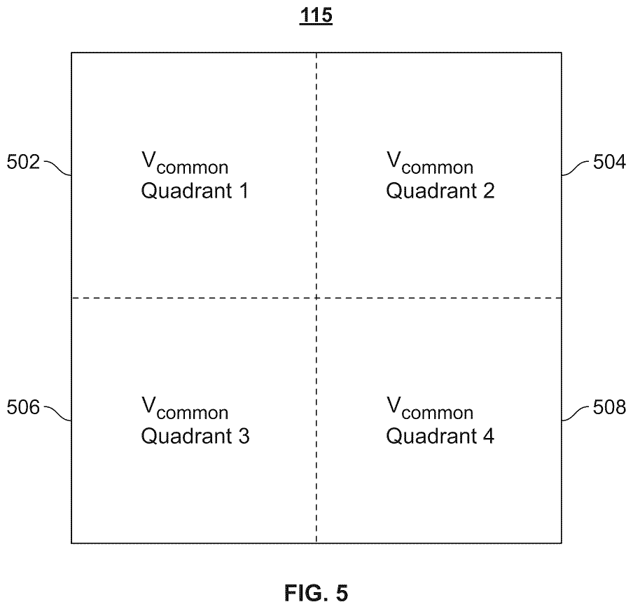

In one embodiment, as shown in FIG. 5, the predefined plurality of regions, sectors or areas is four, thereby identifying four quadrants within the transmission detector panel 115, namely, a first quadrant 502, a second quadrant 504, a third quadrant 506 and a fourth quadrant 508. Each of the first quadrant 502, a second quadrant 504, a third quadrant 506 and a fourth quadrant 508 of the plurality of detector elements or pixels of the transmission detector panel 115, has respectively associated therewith a first subset of detector elements or pixels, a second subset of detector elements or pixels, a third subset of detector elements or pixels and a fourth subset of detector elements or pixels.

As discussed earlier, with reference to FIG. 2B, the common bias line 224 has the diode common voltage 227 and associated common bias current 225 for the detector element or pixel 220. It should be appreciated that a diode common voltage of the plurality of detector elements or pixels of the transmission detector panel 115 is a conductive plane across the entire panel 115. The common voltage plane can be split into the predefined plurality of regions, sectors or areas—such as, for example, the four quadrants in the embodiment of FIG. 5 so that each of the four quadrants has an associated read-out current indicative of an intensity or strength of X-ray radiation incident on a quadrant. Stated differently, the common bias current is split into the predefined plurality of regions, sectors or areas—such as, for example, the four quadrants in the embodiment of FIG. 5 so that each of the four quadrants has an associated read-out current. Consequently, the first quadrant 502 has an associated first read-out current data, the second quadrant 504 has an associated second read-out current data, the third quadrant 506 has an associated third read-out current data and the fourth quadrant 508 has an associated fourth read-out current data.

Accordingly, in some embodiments, the transmission detector panel 115 communicates, to the computing device 125, the first read-out current data corresponding to the first subset of detector elements or pixels of the first quadrant 502, the second read-out current data corresponding to the second subset of detector elements or pixels of the second quadrant 504, the third read-out current data corresponding to the third subset of detector elements or pixels of the third quadrant 506 and the fourth read-out current data corresponding to the fourth subset of detector elements or pixels of the fourth quadrant 508.

In some embodiments, the exposure feedback module or engine 130 is configured to process the first, second, third and fourth read-out current data received by the computing device 125 from the transmission detector panel 115 in order to, in real-time, a) determine and indicate if at least a portion of the transmission detector panel 115 is being impinged upon or hit by the X-ray beam 112 (transmitted through and scattered by the target object 140), b) determine a present direction of the X-ray beam 112 and c) indicate at least one direction in which the user needs to maneuver the portable X-ray scanning system 102 to enable the X-ray beam 112 to align with the transmission detector panel 115.

FIG. 3D is a flowchart describing a plurality of exemplary steps of a method 300d for determining and indicating to a user, in real-time, if at least a portion of a transmission detector panel 115 is exposed to or impinged upon by an X-ray beam 112, after transmission through and scattered by a target object 140, in accordance with some embodiments of the present specification. The computing device 125 is configured by the exposure feedback module or engine 130 to implement the method 300d. In one embodiment, as shown in FIG. 5, the transmission detector panel 115 is partitioned into the first quadrant 502, second quadrant 504, third quadrant 506, and fourth quadrant 508, respectively.

Referring now to FIGS. 1A, 1B, 3D and 5, at step 302d the target object 140 is positioned between the portable X-ray scanning system 102 and the first arrangement of transmission detectors that include the transmission detector panel 115 and the plurality of dosimeters 120. In some embodiments, the first arrangement of transmission detectors and the portable X-ray scanning system 102 may not be in visual range of each other.

At step 304d, a user triggers the X-ray source 110 to generate the X-ray beam 112 for a predetermined period of time. In some embodiments, the X-ray source 110 is triggered by, for example, depressing an actuator or trigger (such as a button) of the portable X-ray scanning system 102. The actuator may be held in a depressed state for the predetermined period of time. In some embodiments, the predetermined period of time varies from 5 to 30 seconds.

At step 306d, the transmission detector panel 115 communicates, to the computing device 125, the first read-out current data corresponding to the first subset of detector elements or pixels of the first quadrant 502, the second read-out current data corresponding to the second subset of detector elements or pixels of the second quadrant 504, the third read-out current data corresponding to the third subset of detector elements or pixels of the third quadrant 506 and the fourth read-out current data corresponding to the fourth subset of detector elements or pixels of the fourth quadrant 508. In some embodiments, each of the first, second, third and fourth read-out current data is indicative of an intensity or strength of X-ray radiation incident on the corresponding detector quadrant due to the X-ray beam 112 transmitted through and scattered by the target object 140.

At step 308d, the computing device 125 sums or integrates the first, second, third and fourth read-out current data to determine a summed read-out current data for the transmission detector panel 115.

At step 310d, the computing device 125 compares the summed read-out current data to a predetermined threshold read-out current. In some embodiments, the predetermined threshold read-out current is about 100 nA.

If the summed read-out current data is greater than or equal to the predetermined threshold then, at step 312d, the computing device 125 determines that the transmission detector panel 115 is exposed to, hit by, impinged upon, or struck by X-ray beam 112, transmitted through and scattered by the target object 140. Consequently, at step 314d, the computing device 125 generates at least one graphical user interface to display, in real-time, first data indicative of the X-ray beam 112 striking the transmission detector panel 115. In some embodiments, the first data is a virtual element or visual icon such as, for example, a 2D or 3D shape such as a circle, square, any other quadrilateral shape or an icon such as a thumbs-up sign. In embodiments, the virtual element or visual icon may be color-coded such as, for example, in green color. Alternatively, or additionally, the first data may include a textual message conveying that the X-ray beam 112 is striking the transmission detector panel 115 and that the system will begin acquiring scan data.

Alternatively, or additionally, in some embodiments, the computing device 125 may generate an auditory indicator, such as a sound or beep indicating that the X-ray beam 112 is striking the transmission detector panel 115. Still alternatively, or additionally, in some embodiments, the computing device 125 may generate a visual indicator such as a beacon of light of, say, green color (indicative of the X-ray beam 112 is striking the transmission detector panel 115) on an external surface of the portable X-ray scanning system 102. For example, when the portable X-ray scanning system 102 is a handheld device, the beacon of light may be generated on the external surface of a body or housing of the handheld device.

Thereafter, at step 316d, the computing device 125 automatically begins acquisition of scan data from the transmission detector panel 115.

However, if the summed read-out current data is less than the predetermined threshold then, at step 318d, the computing device 125 determines that the transmission detector panel 115 is not exposed to, hit by, impinged upon or struck by X-ray beam 112, transmitted through and scattered by the target object 140. Consequently, at step 320d, the computing device displays, in real-time within the at least one graphical user interface, second data indicative of the X-ray beam 112 not striking the transmission detector panel 115. In some embodiments, the second data is a virtual element or visual icon such as, for example, a 2D or 3D shape such as a circle, square, any other quadrilateral shape or an icon such as a thumbs-down sign. In embodiments, the virtual element or visual icon that is representative of the second data may be color-coded such as, for example, in red color. Alternatively, or additionally, the second data may include a textual message conveying that the X-ray beam 112 is not striking the transmission detector panel 115 and that the user must align the portable X-ray scanning system 102 and/or the transmission detector panel 115 in order for the system to begin acquiring scan data.

Still alternatively, or additionally, in some embodiments, the computing device 125 may generate a visual indicator such as a beacon of light of, say, a red color (indicating that the X-ray beam 112 is not striking the transmission detector panel 115) on an external surface of the portable X-ray scanning system 102. For example, when the portable X-ray scanning system 102 is a handheld device, the beacon of light may be generated on the external surface of a body or housing of the handheld device.

Thereafter, at step 322d, the computing device 125 stops acquiring scan data from the transmission detector panel 115 until it is confirmed that the X-ray beam 112 is striking at least a portion of the transmission detector panel 115.

A first Method of Determining a Direction of the X-Ray Beam 112

FIG. 3E is a flowchart describing a plurality of exemplary steps of a method 300e for determining, in real-time, a direction of an X-ray beam 112 with reference to a transmission detector panel 115, and indicating to a user, in real-time, at least one direction in which the portable X-ray scanning system 102 should be maneuvered in order for the X-ray beam 112 to strike the transmission detector panel 115, in accordance with some embodiments of the present specification. The computing device 125 is configured by the exposure feedback module or engine to implement the method 300e. In one embodiment, as shown in FIG. 5, the transmission detector panel 115 is partitioned into the first quadrant 502, second quadrant 504, third quadrant 506, and fourth quadrant 508, respectively.

Referring now to FIGS. 1A, 1B, 3E and 5, at step 302e the target object 140 is positioned between the portable X-ray scanning system 102 and the first arrangement of transmission detectors that include the transmission detector panel 115 and the plurality of dosimeters 120. In some embodiments, the first arrangement of transmission detectors and the portable X-ray scanning system 102 may not be in visual range of each other.

At step 304e, the user triggers the X-ray source 110 to generate the X-ray beam 112 for a predetermined period of time. In some embodiments, the predetermined period of time varies from 5 to 30 seconds.

At step 306e, the transmission detector panel 115 communicates, to the computing device 125, the first read-out current data corresponding to the first subset of detector elements or pixels of the first quadrant 502, the second read-out current data corresponding to the second subset of detector elements or pixels of the second quadrant 504, the third read-out current data corresponding to the third subset of detector elements or pixels of the third quadrant 506 and the fourth read-out current data corresponding to the fourth subset of detector elements or pixels of the fourth quadrant 508. In some embodiments, each of the first, second, third and fourth read-out current data is indicative of an intensity or strength of X-ray radiation incident on the corresponding detector quadrant due to the X-ray beam 112 transmitted through and scattered by the target object 140.

At step 308e, the computing device 125 compares the first, second, third and fourth read-out current data with each other in order to determine a maximum read-out current data from the first, second, third and fourth read-out current data.

At step 310e, the computing device 125 determines a present direction of the X-ray beam 112 based on an extent of skewness towards a quadrant (of the first quadrant 502, second quadrant 504, third quadrant 506, and fourth quadrant 508, respectively) wherein the extent of skewness corresponds to the maximum read-out current data. For example, if the first read-out current data is maximum then the computing device 125 determines that the direction of the X-ray beam 112 is skewed towards the first quadrant 502, if the second read-out current data is maximum then the computing device 125 determines that the direction of the X-ray beam 112 is skewed towards the second quadrant 504, if the third read-out current data is maximum then the computing device 125 determines that the direction of the X-ray beam 112 is skewed towards the third quadrant 506, whereas if the fourth read-out current data is maximum then the computing device 125 determines that the direction of the X-ray beam 112 is skewed towards the fourth quadrant 508.

At step 312e, based on the present direction of the X-ray beam 112, the computing device 125 generates at least one graphical user interface to display, in real-time, navigation data indicative of a direction in which the portable X-ray scanning system 102 should be maneuvered in order for the X-ray beam 112 to strike or expose at least a portion of the transmission detector panel 115.

In some embodiments, the navigation data is a virtual element such as, for example, at least one arrow indicative of the direction in which the portable X-ray scanning system 102 should be maneuvered. In some embodiments, the at least one arrow may be color-coded in a first color, such as in red (when the X-ray beam is not striking at least a portion of the transmission detector panel), and may gradually transition to a second color, such as green, when the X-ray beam 112 is striking at least a portion of the transmission detector panel 115 while maneuvering the portable X-ray scanning system 102 along the direction indicated by the at least one arrow.

In some embodiments, if the direction of the X-ray beam 112 is skewed towards the first quadrant 502 then first and second arrows may be simultaneously displayed wherein the first arrow points towards the right indicating to the user that the portable X-ray scanning system 102 should be maneuvered towards the right and the second arrow points down indicating that the portable X-ray scanning system 102 should also be maneuvered downwards.

If the direction of the X-ray beam 112 is skewed towards the second quadrant 504 then third and fourth arrows may be simultaneously displayed wherein the third arrow points towards the left indicating to the user that the portable X-ray scanning system 102 should be maneuvered towards the left and the fourth arrow points down indicating that the portable X-ray scanning system 102 should also be maneuvered downwards.

If the direction of the X-ray beam 112 is skewed towards the third quadrant 506 then fifth and sixth arrows may be simultaneously displayed wherein the fifth arrow points towards the right indicating to the user that the portable X-ray scanning system 102 should be maneuvered towards the right and the sixth arrow points up indicating that the portable X-ray scanning system 102 should also be maneuvered upwards.

If the direction of the X-ray beam 112 is skewed towards the fourth quadrant 508 then seventh and eighth arrows may be simultaneously displayed wherein the seventh arrow points towards the left indicating to the user that the portable X-ray scanning system 102 should be maneuvered towards the left and the eighth arrow points up indicating that the portable X-ray scanning system 102 should also be maneuvered upwards.

Alternatively, or additionally, in some embodiments, visual indicators, such as beacons of light may be generated on an external surface of the portable X-ray scanning system 102. For example, when the portable X-ray scanning system 102 is a handheld device, the beacon of light may be generated on the external surface of a body or housing of the handheld device. These beacons of light may augment or may be provided instead of the first, second, third, fourth, fifth, sixth, seventh and eighth guidance arrows, in various embodiments.

It should be appreciated that, in some embodiments, step 306e to 312e are executed if it has been determined, by the computing device 125, that the X-ray beam 112 does not impinge upon or strike the transmission detector panel 115, wherein such determination is made using a method such as method 300a of FIG. 3A, method 300b of FIG. 3B, method 300c of FIG. 3C and/or method 300d of FIG. 3D.

### A Second Method of Determining a Direction of the X-Ray Beam 112

FIG. 3F is a flowchart describing a plurality of exemplary steps of a method 300f for determining, in real-time, a direction of an X-ray beam 112 with reference to a transmission detector panel 115, and indicating to a user, in real-time, at least one direction in which the portable X-ray scanning system 102 should be maneuvered in order for the X-ray beam 112 to strike the transmission detector panel 115, in accordance with some embodiments of the present specification. The computing device 125 is configured by the exposure feedback module or engine to implement the method 300f. In one embodiment, as shown in FIG. 5, the transmission detector panel 115 is partitioned into the first quadrant 502, second quadrant 504, third quadrant 506, and fourth quadrant 508, respectively.

Referring now to FIGS. 1A, 1B, 3F and 5, at step 302f the target object 140 is positioned between the portable X-ray scanning system 102 and the first arrangement of transmission detectors that include the transmission detector panel 115 and the plurality of dosimeters 120. In some embodiments, the first arrangement of transmission detectors and the portable X-ray scanning system 102 may not be in visual range of each other.

At step 304f, the user triggers the X-ray source 110 to generate the X-ray beam 112 for a predetermined period of time. In some embodiments, the predetermined period of time varies from 5 to 30 seconds.

At step 306f, the transmission detector panel 115 communicates, to the computing device 125, the first read-out current data corresponding to the first subset of detector elements or pixels of the first quadrant 502, the second read-out current data corresponding to the second subset of detector elements or pixels of the second quadrant 504, the third read-out current data corresponding to the third subset of detector elements or pixels of the third quadrant 506 and the fourth read-out current data corresponding to the fourth subset of detector elements or pixels of the fourth quadrant 508. In some embodiments, each of the first, second, third and fourth read-out current data is indicative of an intensity or strength of X-ray radiation incident on the corresponding detector quadrant due to the X-ray beam 112 transmitted through and scattered by the target object 140.

At step 308f, the computing device 125 determines a) first summed readout current data based on a summation of the first and second read-out current data, wherein the first summed readout current data corresponds to a first half of the transmission detector panel 115, the first half including the first quadrant 502 and the second quadrant 504, b) second summed readout current data based on a summation of the second and fourth read-out current data, wherein the second summed readout current data corresponds to a second half of the transmission detector panel 115, the second half including the second quadrant 504 and the fourth quadrant 508, c) third summed readout current data based on a summation of the third and fourth read-out current data, wherein the third summed readout current data corresponds to a third half of the transmission detector panel 115, the third half including the third quadrant 506 and the fourth quadrant 508, and d) fourth summed readout current data based on a summation of the first and third read-out current data, wherein the fourth summed readout current data corresponds to a fourth half of the transmission detector panel 115, the fourth half including the first quadrant 502 and the third quadrant 506.

At step 310f, the computing device 125 compares the first, second, third and fourth summed read-out current data with each other in order to determine a maximum summed read-out current data from the first, second, third and fourth summed read-out current data.

At step 312f, the computing device 125 determines a present direction of the X-ray beam 112 based on an extent of skewness towards a half (of the transmission detector panel 115) wherein the extent of skewness corresponds to the maximum summed read-out current data.

For example, if the first summed read-out current data is maximum then the computing device 125 determines that the direction of the X-ray beam 112 is skewed towards the first half, if the second read-out current data is maximum then the computing device 125 determines that the direction of the X-ray beam 112 is skewed towards the second half, if the third read-out current data is maximum then the computing device 125 determines that the direction of the X-ray beam 112 is skewed towards the third half, whereas if the fourth read-out current data is maximum then the computing device 125 determines that the direction of the X-ray beam 112 is skewed towards the fourth half.

At step 314f, based on the present direction of the X-ray beam 112, the computing device 125 generates at least one graphical user interface to display, in real-time, navigation data indicative of a direction in which the portable X-ray scanning system 102 should be maneuvered in order for the X-ray beam 112 to strike or expose at least a portion of the transmission detector panel 115.

In some embodiments, the navigation data is a virtual element such as, for example, at least one arrow indicative of the direction in which the portable X-ray scanning system 102 should be maneuvered. In some embodiments, the at least one arrow may be color-coded in a first color, such as in red, and may gradually transition to a second color, such as green, when the X-ray beam 112 is striking at least a portion of the transmission detector panel 115 by maneuvering the portable X-ray scanning system 102 along the direction indicated by the at least one arrow.

In some embodiments, if the direction of the X-ray beam 112 is skewed towards the first half then a first arrow may be displayed that points down indicating that the portable X-ray scanning system 102 should be maneuvered downwards.

In some embodiments, if the direction of the X-ray beam 112 is skewed towards the second half then a second arrow may be displayed that points left indicating that the portable X-ray scanning system 102 should be maneuvered towards the left.

In some embodiments, if the direction of the X-ray beam 112 is skewed towards the third half then a third arrow may be displayed that points up indicating that the portable X-ray scanning system 102 should be maneuvered upwards.

In some embodiments, if the direction of the X-ray beam 112 is skewed towards the fourth half then a fourth arrow may be displayed that points right indicating that the portable X-ray scanning system 102 should be maneuvered towards the right.

Alternatively, or additionally, in some embodiments, beacons of lights may be generated on an external surface of the portable X-ray scanning system 102. For example, when the portable X-ray scanning system 102 is a handheld device, the beacons of light may be generated on the external surface of a body or housing of the handheld device. These beacons of lights may augment or may be provided instead of the first, second, third, and fourth guidance arrows, in various embodiments.

It should be appreciated that, in some embodiments, steps 306d to 314d are executed if it has been determined, by the computing device 125, that the X-ray beam 112 does not impinge upon or strike the transmission detector panel 115, wherein such determination is made using a method such as method 300a of FIG. 3A, method 300b of FIG. 3B, method 300c of FIG. 3C and/or method 300d of FIG. 3D.

### A Third Method of Determining a Direction of the X-Ray Beam 112

FIG. 3G is a flowchart describing a plurality of exemplary steps of a second method 300g for determining, in real-time, a direction of the X-ray beam 112 with reference to the transmission detector panel, and indicating to a user, in real-time, at least one direction in which the portable X-ray scanning system 102 should be maneuvered in order for the X-ray beam 112 to strike the transmission detector panel 115, in accordance with some embodiments of the present specification. The computing device 125 is configured by the exposure feedback module or engine 130 to implement the method 300g. As shown in FIGS. 1A and 1B, the plurality of dosimeters 120 include first dosimeter 120a, second dosimeter 120b, third dosimeter 120c, and fourth dosimeter 120d each of which is positioned external to the transmission detector panel 115.

Referring now to FIGS. 1A, 1B, and 3G, at step 302g the target object 140 is positioned between the portable X-ray scanning system 102 and the first arrangement of transmission detectors that include the transmission detector panel 115 and first dosimeter 120a, second dosimeter 120b, third dosimeter 120c, and fourth dosimeter 120d. In some embodiments, the first arrangement of transmission detectors and the portable X-ray scanning system 102 may not be in visual range of each other.

At step 304g, the user triggers the X-ray source 110 to generate the X-ray beam 112 for a predetermined period of time. In some embodiments, the predetermined period of time varies from 5 to 30 seconds.

At step 306g, the computing device 125 receives a first dosimeter read-out current data from the first dosimeter 120a, a second dosimeter read-out current data from the second dosimeter 120b, a third dosimeter read-out current data from the third dosimeter 120c, and a fourth dosimeter read-out current data from the fourth dosimeter 120d. In some embodiments, each of the first, second, third and fourth dosimeter read-out current data is indicative of an intensity or strength of X-ray radiation incident on the corresponding dosimeter due to the X-ray beam 112 transmitted through and scattered by the target object 140.

At step 308g, the computing device 125 compares the first, second, third and fourth dosimeter read-out current data with each other in order to determine the maximum dosimeter read-out current data from the first, second, third and fourth dosimeter read-out current data.

At step 310g, the computing device 125 determines a present direction of the X-ray beam 112 based on an extent of skewness towards a dosimeter (of the first dosimeter 120a, second dosimeter 120b, third dosimeter 120c, and/or fourth dosimeter 120d) corresponding to the maximum dosimeter read-out current data. For example, if the first dosimeter read-out current data is maximum then the computing device 125 determines that the direction of the X-ray beam 112 is skewed towards the first dosimeter 120a, if the second dosimeter read-out current data is maximum then the computing device 125 determines that the direction of the X-ray beam 112 is skewed towards the second dosimeter 120b, if the third dosimeter read-out current data is maximum then the computing device 125 determines that the direction of the X-ray beam 112 is skewed towards the third dosimeter 120c, whereas if the fourth dosimeter read-out current data is maximum then the computing device 125 determines that the direction of the X-ray beam 112 is skewed towards the fourth dosimeter 120d.

At step 312g, based on the determined present direction of the X-ray beam 112, the computing device 125 generates at least one graphical user interface to display, in real-time, navigation data indicative of a direction in which the portable X-ray scanning system 102 should be maneuvered in order for the X-ray beam 112 to strike the transmission detector panel 115.

In some embodiments, the navigation data is a virtual element such as, for example, at least one arrow indicative of the direction in which the portable X-ray scanning system 102 should be maneuvered. In some embodiments, the at least one arrow may be color-coded in a first color, such as in red, and may gradually transition to a second color, such as green, when the X-ray beam 112 is aligned with the transmission detector panel 115 along the direction indicated by the at least one arrow.

In some embodiments, if the direction of the X-ray beam 112 is skewed towards the first dosimeter 120a then a first arrow may be displayed pointing down indicating to the user that the portable X-ray scanning system 102 should be maneuvered downwards.

If the direction of the X-ray beam 112 is skewed towards the second dosimeter 120b then a second arrow may be displayed pointing right indicating to the user that the portable X-ray scanning system 102 should be maneuvered towards the right.

If the direction of the X-ray beam 112 is skewed towards the third dosimeter 120c then a third arrow may be displayed pointing up indicating to the user that the portable X-ray scanning system 102 should be maneuvered upwards.

If the direction of the X-ray beam 112 is skewed towards the fourth dosimeter 120d then a fourth arrow may be displayed pointing left indicating to the user that the portable X-ray scanning system 102 should be maneuvered towards the left.

Alternatively, or additionally, in some embodiments, visual indicators such as beacons of light may be generated on an external surface of the portable X-ray scanning system 102. For example, when the portable X-ray scanning system 102 is a handheld device, the beacons of light may be generated on the external surface of a body or housing of the handheld device. These beacon lights may augment or be provided instead of the first, second, third, fourth, fifth, sixth, seventh and eighth guidance arrows, in various embodiments.

It should be appreciated that, in some embodiments, steps 306d to 312d are executed if it has been determined, by the computing device 125, that the X-ray beam 112 does not strike the transmission detector panel 115, wherein such determination is made using a method such as method 300a of FIG. 3A, method 300b of FIG. 3B, method 300c of FIG. 3C and/or method 300d of FIG. 3D.

### A Fourth Method of Determining a Direction of the X-Ray Beam 112

FIG. 3H is a flowchart describing a plurality of exemplary steps of a method 300h for determining, in real-time, a direction of the X-ray beam 112 with reference to the transmission detector panel 115, and indicating to a user, in real-time, at least one direction in which the portable X-ray scanning system 102 should be maneuvered in order for the X-ray beam 112 to strike the transmission detector panel 115, in accordance with some embodiments of the present specification. The computing device 125 is configured by the exposure feedback module or engine to implement the method 300h. As shown in FIGS. 1A and 1B, the plurality of dosimeters 120 include first dosimeter 120a, second dosimeter 120b, third dosimeter 120c, and fourth dosimeter 120d each of which is positioned external to the transmission detector panel 115.

Referring now to FIGS. 1A, 1B, and 3H, at step 302h the target object 140 is positioned between the portable X-ray scanning system 102 and the first arrangement of transmission detectors that include the transmission detector panel 115 and the first dosimeter 120a, second dosimeter 120b, third dosimeter 120c, and fourth dosimeter 120d. In some embodiments, the first arrangement of transmission detectors and the portable X-ray scanning system 102 may not be in visual range of each other.

At step 304h, the user triggers the X-ray source 110 to generate the X-ray beam 112 for a predetermined period of time. In some embodiments, the X-ray source 110 is triggered by, for example, depressing an actuator or trigger (such as a button) of the portable X-ray scanning system 102. The actuator may be held in a depressed state for the predetermined period of time. In some embodiments, the predetermined period of time varies from 5 to 30 seconds.

At step 306h, the computing device 125 receives a first dosimeter read-out current data from the first dosimeter 120a, a second dosimeter read-out current data from the second dosimeter 120b, a third dosimeter read-out current data from the third dosimeter 120c, and a fourth dosimeter read-out current data from the fourth dosimeter 120d. In some embodiments, each of the first, second, third and fourth dosimeter read-out current data is indicative of an intensity or strength of X-ray radiation incident on the corresponding dosimeter due to the X-ray beam 112 transmitted through and scattered by the target object 140.

At step 308h, the computing device 125 compares the first, second, third and fourth dosimeter read-out current data with each other in order to determine the highest dosimeter read-out current data and the next highest dosimeter read-out data from the first, second, third and fourth dosimeter read-out current data.

At step 310h, the computing device 125 determines a first signal-to-noise ratio (SNR) for the dosimeter corresponding to the highest dosimeter read-out current data and a second signal-to-noise ratio (SNR) for the dosimeter corresponding to the next highest dosimeter read-out current data.

At step 312h, the computing device 125 determines if at least one of the first and second SNR is greater than 0.5.

If none of the first and second SNR is greater than 0.5 then, at step 318h the computing device 125 determines that the X-ray beam 112 is not striking the transmission detector panel 115 and therefore no direction information is generated (since, the X-ray beam 112 is not close enough to the transmission detector panel 115 for a direction of the X-ray beam 112 to be determined).

If at least one of the first and second SNR is greater than 0.5 then, at step 314h, the computing device 125 determines a present direction of the X-ray beam 112 by calculating an angle θ to the scatter source using the equation: θ=[a*tan (ratio of highest and next highest dosimeter read-out current)], wherein ‘a’ is a mathematical function of the arc tangent.

At step 316h, based on the present direction of the X-ray beam 112, the computing device 125 generates at least one graphical user interface to display, in real-time, navigation data indicative of a direction in which the portable X-ray scanning system 102 should be maneuvered in order for the X-ray beam 112 to strike the transmission detector panel 115.

In some embodiments, the navigation data is a virtual element such as, for example, at least one arrow indicative of the direction in which the portable X-ray scanning system 102 should be maneuvered. In some embodiments, the at least one arrow may be color-coded in a first color, such as in red, and may gradually transition to a second color, such as green, when the X-ray beam 112 is striking at least a portion of the transmission detector panel 115 along the direction indicated by the at least one arrow.

In some embodiments, if the direction of the X-ray beam 112 is skewed towards the first dosimeter 120a then a first arrow may be displayed pointing down indicating to the user that the portable X-ray scanning system 102 should be maneuvered downwards.

If the direction of the X-ray beam 112 is skewed towards the second dosimeter 120b then a second arrow may be displayed pointing right indicating to the user that the portable X-ray scanning system 102 should be maneuvered towards the right.

If the direction of the X-ray beam 112 is skewed towards the third dosimeter 120c then a third arrow may be displayed pointing up indicating to the user that the portable X-ray scanning system 102 should be maneuvered upwards.

If the direction of the X-ray beam 112 is skewed towards the fourth dosimeter 120d then a fourth arrow may be displayed pointing left indicating to the user that the portable X-ray scanning system 102 should be maneuvered towards the left.

In some embodiments, if the direction of the X-ray beam 112 is skewed towards the first dosimeter 120a and second dosimeter 120b, then fifth and sixth arrows may be simultaneously displayed wherein the fifth arrow points towards the right indicating to the user that the portable X-ray scanning system 102 should be maneuvered towards the right and the sixth arrow points down indicating that the portable X-ray scanning system 102 should also be maneuvered downwards.

If the direction of the X-ray beam 112 is skewed towards the first dosimeter 120a and fourth dosimeter 120d, then seventh and eighth arrows may be simultaneously displayed wherein the seventh arrow points towards the left indicating to the user that the portable X-ray scanning system 102 should be maneuvered towards the left and the eighth arrow points down indicating that the portable X-ray scanning system 102 should also be maneuvered downwards.

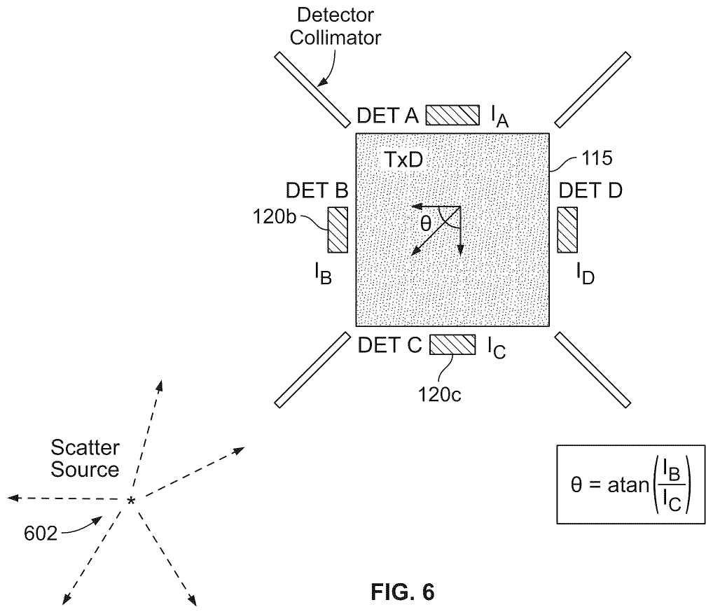

If the direction of the X-ray beam 112 is skewed towards the second dosimeter 120b and third dosimeter 120c, then ninth and tenth arrows may be simultaneously displayed wherein the ninth arrow points towards the right indicating to the user that the portable X-ray scanning system 102 should be maneuvered towards the right and the tenth arrow points up indicating that the portable X-ray scanning system 102 should also be maneuvered upwards. FIG. 6 shows a scenario where the X-ray beam 112 (not shown), after having passed through and scattered by a scattering source 602, is skewed towards the second and third dosimeters 120b, 120c respectively, with reference to the transmission detector panel 115, in accordance with some embodiments of the present specification.

If the direction of the X-ray beam 112 is skewed towards the third dosimeter 120c and fourth dosimeter 120d, then eleventh and twelfth arrows may be simultaneously displayed wherein the eleventh arrow points towards the left indicating to the user that the portable X-ray scanning system 102 should be maneuvered towards the left and the twelfth arrow points up indicating that the portable X-ray scanning system 102 should also be maneuvered upwards.

Alternatively, or additionally, in some embodiments, visual indicators such as beacons of light may be generated on an external surface of the portable X-ray scanning system 102. For example, when the portable X-ray scanning system 102 is a handheld device, the beacons of light may be generated on the external surface of a body or housing of the handheld device. These beacons of light may augment or replace the guidance arrows, in various embodiments.

It should be appreciated that, in some embodiments, steps 306f to 318f are executed if it has been determined, by the computing device 125, that the X-ray beam 112 does not strike the transmission detector panel 115, wherein such determination is made using a method such as method 300a of FIG. 3A, method 300b of FIG. 3B, method 300c of FIG. 3C and/or method 300d of FIG. 3D.

The systems and methods of the present specification support at least the following advantages: a) provide real-time feedback to the user regarding the quality of positioning of the portable X-ray scanning system with respect to the transmission detector panel, b) enable X-ray imaging workflow time to be optimized, c) enable scans where the transmission detector panel and the portable X-ray scanning system are not in visual range of each other, d) enable automatic triggering of the start of the first arrangement of transmission detectors, e) the cost of implementation of the systems and methods of aligning the X-ray beam to the transmission detector panel is a small fraction of the total system cost, and f) the first arrangement of transmission detectors and the portable X-ray scanning system together have a light-weight and compact size.

The above examples are merely illustrative of the many applications of the systems and methods of the present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A system for scanning a target object, comprising:
a X-ray scanning system having an X-ray source configured to emit a spatially localized X-ray beam onto the target object;
a transmission detector positioned such that the target object is positioned between the X-ray scanning system and the transmission detector;
a computing device in data communication with the X-ray scanning system and the transmission detector, wherein the computing device comprises a processor and a non-volatile memory storing a plurality of programmatic code which when executed cause the processor to:
trigger the X-ray source to generate the X-ray beam;
receive digital detection data from the transmission detector;
compare the digital detection data to a predetermined value range; and
display, in at least one graphical user interface, first data indicative of the X-ray beam striking the transmission detector if the digital detection data is within the value range or display second data indicative of the X-ray beam not striking the transmission detector if the digital detection data is not within the value range.

2. The system of claim 1, wherein the X-ray scanning system is configured as a handheld scanner.

3. The system of claim 1, wherein a position of the transmission detector is not fixed relative to the X-ray scanning system.

4. The system of claim 1, wherein the digital detection data is indicative of a dose rate of X-ray radiation incident on the transmission detector due to the X-ray beam transmitted through and scattered by the target object.

5. The system of claim 4, wherein the value range of the dose rate is 100 μR/hr to 1000 μR/hr.

6. The system of claim 1, wherein the digital detection data is indicative of a common bias current of an array of detector elements or pixels of the transmission detector.

7. The system of claim 6, wherein the value range of the common bias current is 50 nA to 200 nA.

8. The system of claim 1, wherein the first data is represented by a visual icon, the second data is represented by a visual icon, and wherein the visual icon of the first data is visually different than the icon of the second data.

9. The system of claim 1, wherein each of the first data and the second data is represented by an auditory indicator and wherein the auditory indicator of the first data is different from the auditory indicator of the second data.

10. The system of claim 1, wherein a plurality of dosimeters is positioned proximate to the transmission detector.

11. A system for scanning a target object, comprising:
a X-ray scanning system having an X-ray source configured to emit a spatially localized X-ray beam onto the target object;
a transmission detector defined by a plurality of pixels and positioned between the X-ray scanning system and the target object, wherein the transmission detector has a first quadrant region, a second quadrant region, a third quadrant region and a fourth quadrant region, and wherein each of the first, second, third and fourth quadrant regions has an associated subset of pixels of the plurality of pixels;
a computing device in data communication with the X-ray scanning system and the transmission detector, wherein the computing device comprises a processor and a non-volatile memory storing a plurality of programmatic code which, when executed, cause the processor to:
trigger the X-ray source to generate the X-ray beam;
receive, from the transmission detector, first read-out current data from the first quadrant, second read-out current data from the second quadrant, third read-out current data from the third quadrant and fourth read-out current data the fourth quadrant region;
sum the first, second, third and fourth read-out current data in order to generate summed read-out current data;
compare the summed read-out current data to a predetermined value range; and
display, in at least one graphical user interface, first data indicative of the X-ray beam striking the transmission detector or second data indicative of the X-ray beam not striking the transmission detector based on the comparison of the summed read-out current data to the predetermined value range.

12. The system of claim 11, wherein the X-ray scanning system is configured as a handheld scanner.

13. The system of claim 11, wherein a position of the transmission detector is not fixed relative to the X-ray scanning system.

14. The system of claim 11, wherein each of the first, second, third and fourth read-out current data are indicative of an intensity of X-ray radiation incident on the corresponding quadrant region.

15. The system of claim 11, wherein the value range of the dose rate is 100 μR/hr to 1000 μR/hr.

16. The system of claim 11, wherein the first data is represented by a visual icon, the second data is represented by a visual icon, and wherein the visual icon of the first data is visually different than the icon of the second data.

17. The system of claim 11, wherein each of the first data and the second data is represented by an auditory indicator and wherein the auditory indicator of the first data is different from the auditory indicator of the second data.

18. The system of claim 11, wherein if the summed read-out current data is less than the predetermined value range, the plurality of programmatic code further cause the processor to:
determine a maximum read-out current data from the first, second, third and fourth read-out current data;
determine a direction of the X-ray beam relative to the first, second, third and/or fourth quadrant regions based on the maximum read-out current data; and
display, in the at least one graphical user interface, navigation data indicative of a direction in which the X-ray scanning system should be maneuvered in order for the X-ray beam to be aligned with the transmission detector.

19. The system of claim 18, wherein the navigation data comprises one or more visual arrows indicative of a direction in which the X-ray scanning system should be maneuvered.

20. The system of claim 11, wherein a plurality of dosimeters is positioned proximate to the transmission detector.
